(19) United States
(12) Patent Application Publication
(10) Pub. No.: US 2024/0028350 A1
(43) Pub. Date: Jan. 25, 2024

(54) VISUALLY EXPRESSIVE CREATION AND COLLABORATION AND ASYNCRONOUS MULTIMODAL COMMUNCIATION FOR DOCUMENTS

(71) Applicant: Second Layer, Inc., San Jose, CA (US)

(72) Inventors: Pramod Sharma, San Jose, CA (US); Jerome Scholler, Jacou, CA (US)

(21) Appl. No.: 18/249,381

(22) PCT Filed: Oct. 15, 2021
(86) PCT No.: PCT/US2021/055307

§ 371 Date: Apr. 17, 2023

Related U.S. Application Data
(60) Provisional application No. 63/092,095, filed on Oct. 15, 2020.

(51) Int. Cl. G06F 9/451; G06F 40/169; G06F 3/04845; G06F 3/0488; G06F 3/04855; G06Q 10/101

(52) U.S. Cl. CPC G06F 9/451; G06F 40/169; G06F 3/04845; G06F 3/0488; G06F 3/04855; G06Q 10/101

(57) ABSTRACT

An example machine learning or AI-driven method may include generating a document interface including a document content region configured to display textual and graphical document elements; that the document interface including a visualization input component that is user-selectable to input visualization object elements; providing the document interface for presentation via an output device of a computing device associated with a user; receiving a first input via an input device associated with the computing device; predicting one or more first visualization object elements based on the first input; and updating the document interface to include the one or more predicted first visualization object elements as one or more suggestions.

### TECHNICAL FIELD

The present disclosure relates to communication, and in a more particular non-limiting example, an expressive asynchronous multimodal communication for documents.

### BACKGROUND

People frequently collaborate on documents using popular cloud-based file sharing, word processing, whiteboarding, or other content creation platforms, such as Google Docs™ and/or using tools made available by web-based meeting platforms such as Zoom™. For instance, users can leave text comments and annotations in a word processing, spreadsheet, or presentational document for other users, such as the authoring user(s) to review.

However, user experience with these existing solutions is often fragmented because users frequently must resort to several different tools in order to obtain comprehensive feedback. In particular, most of these solutions are limited to allowing users to leave textual comments for various portions of a document using a comment box. However, conveying complex ideas or thoughts is often difficult to effectively do with textual comments, and as a result, users end up having to meet in person or via video conference to explain or clarify those ideas or thoughts. While some platforms allow users to capture video and annotations, once produced, they are not editable and difficult to collaborate upon.

Further, users are generally required to conform to the commenting and editing tools provided by the platform on which the document resides. Should users wish to gather additional feedback outside that platform, they often have to resort to exporting the document into a different format, such as Adobe's Portable Document Format (PDF) (which strips the comments that were previously made), and then use an entirely different set of collaborative/commenting tools to gather that additional feedback. Ultimately, the stakeholder or authoring user ends up having to manually incorporate feedback from multiple sources to gain a more complete understanding of the users' feedback on the document.

Merely watching a video or presentation is often inefficient because there is typically no intuitive sense of navigation and finding the portions of the video or presentation that may be relevant requires considerable “digging around.” In contrast, a document has navigation structure, but dense text with references to diagrams requires constant looking back and forth, and without voice layers such as emphasis, tone, and mood are missing.

### SUMMARY

The technology disclosed herein addresses the limitations of existing solutions in a number of ways. For example and not limitation, the technology can enable people to communicate effortlessly in multiple “layers” of content at once, react and respond to each other, and build large “constructs” that they can share with others. The technology also uniquely enables people to convey their thoughts and ideas visually without any specialized skill sets using novel, artificial intelligence (AI)-driven design tools. The technology can also beneficially integrate the spatial and temporal dimensions of information, represented canonically by visual elements (e.g., spatial) and audio/video narrative elements (e.g., temporal). The integrative experience provided by the platform allows users to create visually rich, multi-layered content, especially users that lack familiarity with graphic and media production technology, and to easily review, consume, and understand the content created.

According to one innovative aspect of the subject matter being described in this disclosure, an example computer-implemented method includes generating a document interface including a document content region configured to display textual and graphical document elements; that the document interface including a visualization input component that is user-selectable to input visualization object elements; providing the document interface for presentation via an output device of a computing device associated with a user; receiving a first input via an input device associated with the computing device; predicting one or more first visualization object elements based on the first input; and updating the document interface to include the one or more predicted first visualization object elements as one or more suggestions.

These and other implementations may optionally include one or more of: that predicting the one or more first visualization object elements based on the first input comprises determining one or more contextual inputs based on one or more earlier-defined visualization object elements, generating one or more first visualization object element predictions based on the first input and the one or more contextual inputs, determining the one or more predicted first visualization object elements based on the one or more first visualization object element predictions; that determining the one or more predicted first visualization object elements based on the one or more first visualization object element predictions comprises filtering the one or more first visualization object element predictions based on a confidence threshold; determining the first input to be a first visualization design input; receiving a second input; determining the second input to be a second visualization design input; predicting one or more second visualization object elements based on the first visualization design input and the second visualization design input; determining a mathematical relationship between the first input and the second input; mathematically associating the one or more first visualization object elements and one or more second visualization object elements based on the mathematical relationship; receiving a third input modifying an attribute of an element from the one or more first visualization object elements and the one or more second visualization object elements; computing an output based on the mathematical association between the one or more first visualization object elements and the one or more second visualization object elements; updating the document interface to reflect the output; that updating the document interface to include the one or more predicted first visualization object elements comprises one of updating the document interface to suggest a graphical object, updating the document interface to suggest an element for the graphical object, updating the document interface to suggest supplementing the graphical object, updating the document interface to suggest supplementing the element for the graphical object, updating the document interface to suggest reformatting the graphical object, updating the document interface to suggest reformatting an existing element of the graphical object, updating the document interface to suggest replacing the graphical object, updating the document interface to suggest replacing the existing element of the graphical object; that a graphical object comprises one or more one of a graph, chart, table, diagram, and drawing; a graphical object element comprises one or more of a shape, line, dot, legend, title, text, shadow, color, thickness, texture, fill, spacing, positioning, ordering, and shading; predicting the one or more first visualization object elements based on first input includes predicting that the one or more first visualization object elements reflect one or more elements of a graph; receiving a second input; determining the second input to include one or more values for the one or more elements of the graph; updating the document interface to include one or more second suggested graphical elements having one or more adjusted dimensional attributes based on the one or more values; and that the visualization input component is draggable.

According to another innovative aspect of the subject matter being described in this disclosure, an example computer-implemented method may include receiving an input to capture a media stream via a media capture device in association with a document; capturing the media stream; transcribing the media stream to text; segmenting the media stream into a segmented media stream object based on the transcribed text; and providing a media player configured to playback the segmented media stream object.

These and other implementations may optionally include one or more of: that each segment of the segmented media object corresponds to a phrase in the transcribed text; generating a document interface including a document region and a multimodal commenting component having a transcription region configured to display the transcribed text and the media player; providing the document interface for presentation via an input device of a computing device associated with a user; while capturing the media stream, playing back the media stream in the media player and contemporaneously updating the transcription region with the transcribed text; segmenting the media object based on the transcribed text comprises determining two or more sequential phrases comprised by the transcribed text and tagging the media object with two or more timestamps corresponding to the two or more sequential phrases; receiving an annotative input defining an annotative visualization object having one or more visualization object elements while the media stream is being captured; determining an annotation timestamp based on a media stream playback time; storing an annotative visualization object in association with the document; that the annotative visualization object including the segmented media object, the one or more visualization object elements, and the timestamp; updating the document interface to depict the annotative visualization object; predicting an optimized annotative visualization object based on the annotative input; provide the optimized annotative visualization object for presentation via the document interface; receive an acceptance of the optimized annotative visualization object; replace the annotative visualization object with the optimized annotative visualization object; receiving a media playback input; determining one or more annotative visualization objects associated with the media playback input; that each of the one or more annotative visualization objects including an annotation timestamp; playing back the segmented media stream object via the media player; and providing the one or more annotative visualization objects for presentation in association with the playing back of the segmented media stream object based on the annotation timestamp of each of the one or more annotative visualization objects.

According to another innovative aspect of the subject matter being described in this disclosure, a system may include a processor; and a memory storing instructions that, when executed by the processor, cause the system to perform operations comprising: generating a document interface including a document content region configured to display textual and graphical document elements; that the document interface including a visualization input component that is user-selectable to input visualization object elements; providing the document interface for presentation via an output device of a computing device associated with a user; receiving a first input via an input device associated with the computing device; predicting one or more first visualization object elements based on the first input; and updating the document interface to include the one or more predicted first visualization object elements as one or more suggestions.

According to another innovative aspect of the subject matter being described in this disclosure, a system may include a processor; and a memory storing instructions that, when executed by the processor, cause the system to perform operations comprising: receiving an input to capture a media stream via a media capture device in association with a document; capturing the media stream; transcribing the media stream to text; segmenting the media stream into a segmented media stream object based on the transcribed text; and providing a media player configured to playback the segmented media stream object.

According to another innovative aspect of the subject matter being described in this disclosure, a system may include means for generating a document interface including a document content region configured to display textual and graphical document elements; providing the document interface for presentation via an output device of a computing device associated with a user; receiving a first input via an input device associated with the computing device; predicting one or more first visualization object elements based on the first input; and updating the document interface to include the one or more predicted first visualization object elements as one or more suggestions.

According to another innovative aspect of the subject matter being described in this disclosure, a system may include means for receiving an input to capture a media stream via a media capture device in association with a document; capturing the media stream; transcribing the media stream to text; segmenting the media stream into a segmented media stream object based on the transcribed text; and providing a media player configured to playback the segmented media stream object.

Other embodiments of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

This patent or application file contains at least one drawing executed in color. Copies of this patent or patent application publication with color drawings will be provided by the Office upon request and payment of the necessary fee.

This disclosure is illustrated by way of example, and not by way of limitation in the figures of the accompanying drawings in which like reference numerals are used to refer to similar elements.

FIG. 1 depicts a block diagram illustrating an example system for graphically engaging content creation and collaboration.

FIG. 2A depicts a flowchart of an example method for graphically engaging content creation collaboration.

FIG. 2B depicts a flowchart of an example method for predicting visual objects.

FIG. 2C depicts a flowchart of an example method for updating a graphical user interface based on predicted visual objects.

FIGS. 3A-3H depict aspects of an example graphical user interface for graphically engaging content creation collaboration.

FIGS. 4A-4F depict further aspects of an example graphical user interface for graphically engaging content creation collaboration.

FIGS. 5A-5G depict example AI-powered predictive visualization enhancements.

FIGS. 6A-6C depict aspects of an example graphical user interface showing AI-powered multimodal commenting functionality.

FIG. 6D depicts a flowchart of an example method for providing multimodal comments.

FIGS. 7A-7B depict a graphical user interface for creating and/or collaborating on a document.

FIGS. 8A-8G depict example graphical user interface elements for creating a multimodal comment.

FIG. 9 depicts a graphical user interface for creating a multimodal comment with annotations.

FIG. 10 depicts example graphical user interface elements associated with multimodal comments.

FIGS. 11A and 11B depict example graphical user interface elements associated with multimodal comments.

FIG. 12 depicts a block diagram illustrating an example computing device.

### DETAILED DESCRIPTION

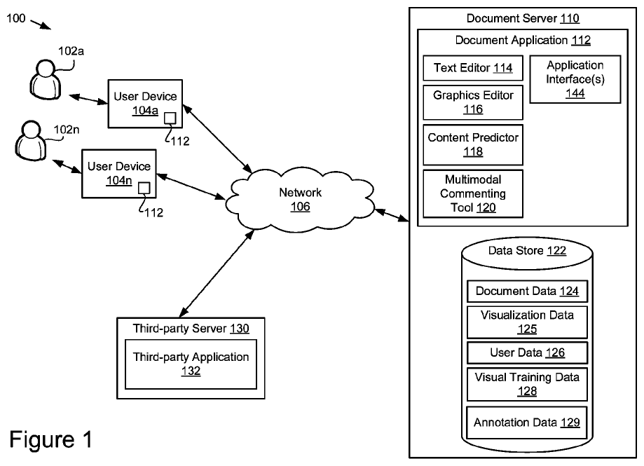

FIG. 1 depicts an example system 100 for graphically engaging content creation and collaboration. As shown, the system may include a document server 110 hosting a document application 112 and a data store 122, a third-party server 130 hosting a third-party application 132, and a plurality of user devices 104a . . . 104n (also simply referred to individually or collectively as 104). In some embodiments, the document server 110 includes one or more servers, a server array or any other computing device or group of computing devices, having data processing, storage, and communication capabilities.

The document server 110, the third-party server 130, and the user devices are electronically communicatively coupled via a network 106. The network 106 may include any number of networks and/or network types. For example, the network 106 may include one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The document application 112 may comprise software and/or hardware logic executable by one processors of the document server 110 to provide for the graphically engaging content creation and collaboration by users 102a . . . 102n that interact with corresponding interfaces displayed by instances of the document application 112 on their user devices. The document application 112 may comprise a distributed web-based application that is accessible by users 102 using software executing on their user devices 104. In this embodiment, a remote instance(s) of the document application 112 may operate on one or more remote servers, such as the document server 110, and the local instances of the document application 112 may send and receive data to/from the remote instance(s). For instance, in such a system 100, the user devices 104 running client-side instances of the document application 112 may be coupled via the network 106 for communication with one another, a third-party server 130 which may embody a document server or other server, the document server 110 hosting a server-side instance of the document application 112 (e.g., embodying the graphically engaging content creation and collaboration service), and/or other entities of the system.

It should be understood that other variations are also possible, such as but not limited to a peer-to-peer embodiment where distributed local instances contain all necessary functionality and are configured to communicate directly with one another, or other embodiments where the same or similar functionality to what is described in this document can be utilized.

The document application 112 may include, but is not limited to, a text editor 114, a graphics editor 116, a content predictor 118, and a multimodal commenting tool, and application interface(s) 144. The text editor 114, graphics editor 116, content predictor 118, multimodal commenting tool, and application interface(s) 144 may each comprise software and/or hardware logic executable by one or more processors to provide the acts and/or functionality disclosed herein.

The data store 122 stores various types of data used by the document application 112. Example data types include document data 124, visualization data 125, user data 126, visual training data 128, and annotation data 129. When performing the acts, operations and functionality described herein, the document application 112 or components thereof may retrieve, store, update, delete or otherwise manipulate the data (e.g., 124, 125, 126, 128, and 129 and or any other data described herein) as applicable.

The document data 124 may comprise documents created and collaborated upon by users 102 of the system 100. A given entry may include a unique identifier for a document and object and/or file data comprising the document. A document may comprise any document that includes visually renderable content, such as text, images, video, etc. A document may reference and/or incorporate other objects, such as visualization objects, annotation objects, graphics, links, etc., using suitable referential data (e.g., unique identifiers, etc.). A document may include data defining the positioning and formatting of the constituent content comprising the document.

A document may be authored using the text editor 114 of the document application 112, or in any other suitable application for producing content, such as, but not limited to, a word processing, spreadsheet, presentation, drawing, image authoring, video authoring, mockup, computer aided design, or other application. Further non-limiting example applications include Google docs, slides, or sheets, Adobe creative cloud and/or PDF applications, Apple keynote, pages, and numbers, Microsoft word, excel, and powerpoint, etc. Any suitable document format or type that, when rendered, depicts content may be utilized. In such cases that a third-party content producing application is being used (e.g., such as one provided by the third-party application 132), the acts and functionality of the graphics editor 116, content predictor 118, and multimodal commenting tool 120 may be accessed using the application interfaces 144, which may include any requisite software development kits (SDKs), application programming interfaces (APIs), or other connective software and/or hardware needed to enable such functionality.

In some embodiments, a presenting or authoring user may connect to a cloud-based authoring application to import or access a document around which the user may wish to collaborate. The document application 112 may authenticate with the cloud-based authoring application using available authentication protocols, receive the selected document object and display it in the document region 714. The user may scroll the different portions (e.g., sections, regions, pages, blocks, etc.) of the document using the scrollbar or suitable gestures, pointer functionality, keyboard keys, such as up and down arrows or page up and page down keys, etc.

Further, access control for the document collaborations may be managed on a per-document or folder basis (document collaborations can be organized in any suitable way and shared accordingly). Document collaborations may be managed in combination with the access control to the document itself or separately from the access to the document, in which case users having access to the document but not the collaboration/messaging layer may only see the document layer and not the messaging layer). Other variations are also possible and contemplated.

The user data 126 may include entries for the users 102 of the system 100. A given entry may include a unique identifier for the user 102, contact information for the user (e.g., address, phone number, electronic address (e.g., email)), payment information, documents created, edited, and/or annotated by the user 102, visualization preference data reflecting frequently used visualizations, etc. User data 126 may reference any other data that may be associated with the user, such as the documents they created or are authorized to view, edit, collaborate on, etc., annotations they have made, content (text, visualizations, etc.) they have made or contribute to, and so forth.

The visualization data 125 may include user-created or default visualization objects. A visualization object may comprise one or more graphical elements (e.g., be a graphical element, a collection of graphical elements, etc.). The one or more graphical elements may be predefined or may be customized by the user. Attributes of the one or more graphical elements of the visualization object may be configurable, such as the size, language, filled, background, pattern, etc. As a user uses the document application 112 to design a new type of visualization object as described in detail herein, the document (e.g., design) application 112 may store an instance of the visualization object as visualization data 125 in the data store 122. The visualization data 125 may include unique identifiers for the visualization objects and their elements so they can be referenced by other data structures, such as the documents, annotation objects, visual training data, and so forth.

The visual training data 128 may include any suitable content that may be used to train the content predictor 118 such that the content predictor 118 can reliably predict the types of visualization objects that are being created by the user using document application 112 as discussed in detail herein. Nonlimiting examples of visual training data 128 may comprise text, shapes, drawings, lines, input trajectory, drawing style, visualization data 127, charts, graphs, tables, infographics, etc.

The annotation data 129 may include any data associated with the multimodal commenting tool 120. Some embodiments, annotation data 129 may include annotation objects reflecting recorded messages left by users in association with documents. An annotation object may include a media object reflecting recordings (audio, video, audiovisual, screen, etc.) left by a user in association with the document or portion thereof, transcription text produced from the media objects, segmentation data reflecting the constituent segments the media object, the transcription text portions (e.g., phrases of the transcription text) corresponding to the media object, the timestamps defining the segments of each media object and corresponding transcription text portions. An annotation object may also include an identifier of any annotative visualization objects input during the capture of media object, and any corresponding annotation timestamps associated with the visualization object elements of the annotative visualization objects. Annotation data 129 may include identifiers for the annotation objects, the documents with which the annotation objects are associated with, as well as identifiers for any constituent components of the annotation objects, such as the annotative visualization objects, transcription text portions, etc., so any elements of the annotation data 129 can be referenced and correlated.

The third-party server 130 is a computing device or system for providing various computing functionalities, services, and/or resources to the other entities of the system 100. In some embodiments, the third-party server 130 includes a server hosting a network-based software application, such as the third-party application 132, operable to provide the computing functionalities, services and/or resources or functionalities, and to send data to and receive data from the document server 110 and the user devices 104a . . . 104n via the network 106. The third-party server 130 may be coupled to the network 106. In some embodiments, the third-party server 130 includes a server, server array or any other computing device, or group of computing devices, having data processing, storage, and communication capabilities.

For example, the third-party server 130 may provide one or more services including word processing, graphic creation, photo editing, social networking; web-based email; blogging; micro-blogging; video, music and multimedia creation, hosting, distribution, and sharing; business services; news and media distribution; or any combination of the foregoing services. It should be understood that the third-party server 130 is not limited to providing the above-noted services and may include any other network-based or cloud-based service. For simplicity, a single block for the third-party server 130 is shown. However, in other embodiments, several distinct third-party servers (not shown) may be coupled to the network via distinct signal lines to provide distinct or competing services. The third-party server 130 may require users to be registered and authenticate to use various functionality provided by the third-party application 132 of the third-party server 130. While not depicted, the third-party server 130 may include data stores and any other required components in order to provide its services and functionality. In some embodiments, the third-party server 130 is coupled to the document server 110 via the network 106 for authenticating a user 104 to access a service provided by the third-party server 130. In these embodiments, the third-party server 130 connects to the document server 110 using an application programming interface (API) to send user credentials, such as data describing the user identifier and a password associated with the user identifier, and to receive an authentication token authorizing the user 104 access to the service. In other embodiments, the third-party server 130 may connect to the document server 110 to utilize the functionality provided thereby.

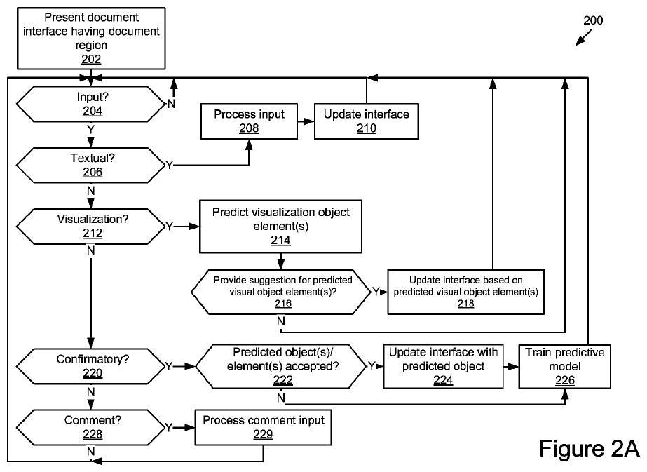

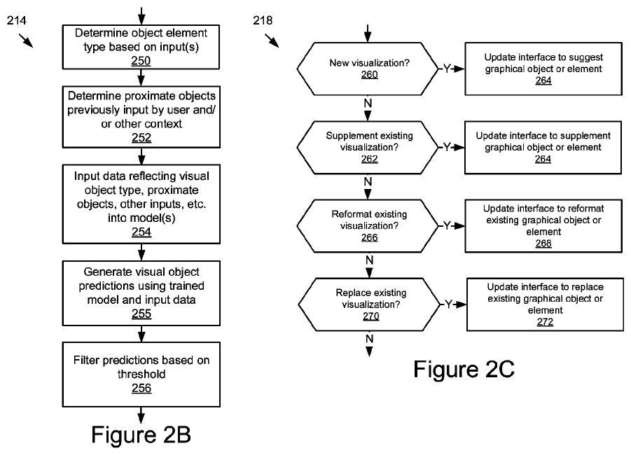

FIG. 2A depicts a flowchart of an example method 200 for graphically engaging content creation collaboration. In block 202, the document application 112 generates a document interface including a document content region configured to display textual and graphical document elements. In some embodiments, the document interface may include a visualization input component that is user-selectable to input visualization object elements. For example, the visualization input component may comprise the visualization editing component 326, the annotation toolbar 703, or another suitable graphics editing interface component capable of creating and editing visualization object elements. These visualization input components may be draggable across the interface depending on the configuration.

By way of example, the document application 112 may provide the document interface (or any of the other interfaces (e.g., 300, 700, 900, etc.) for presentation to users 102. For instance, the document application 112 may comprise code executable via a processor 1204 on a computing device 1200, such as the user device 104 of a user 102 and the interface may be presented on an output device 1216 of the computing device 1200. The users 102 may interact with the presented interfaces (e.g., 300, 700, 900, etc.) using an input device 1214 of the computing device 1200.

The document application 112 may receive sequential inputs (e.g., first, second, third, etc., inputs) from users 104 that are working on a document that define the content of the document, provide comments on the document, revise the document, enhance the document and so forth.

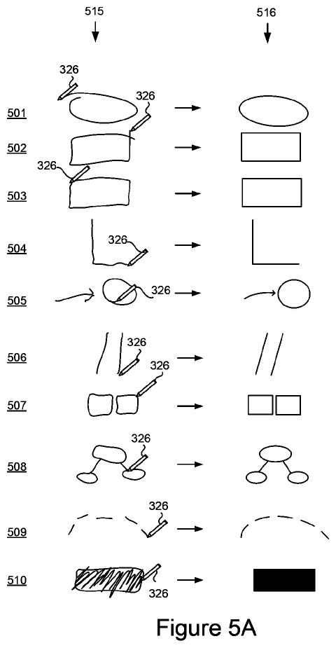

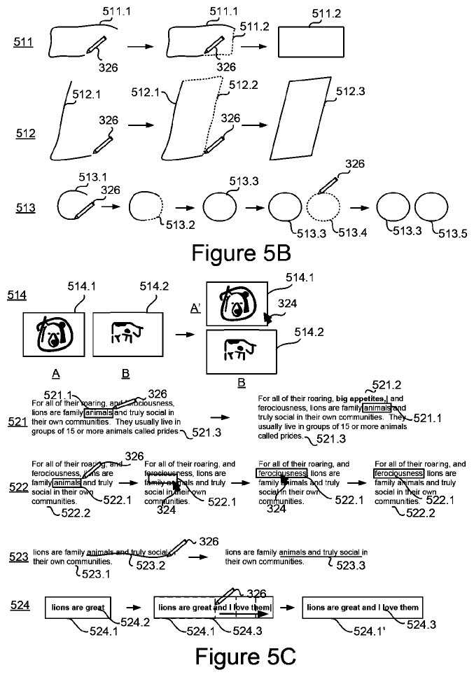

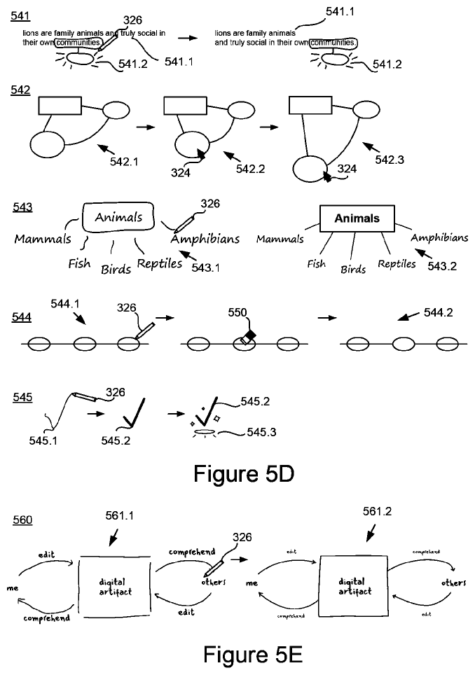

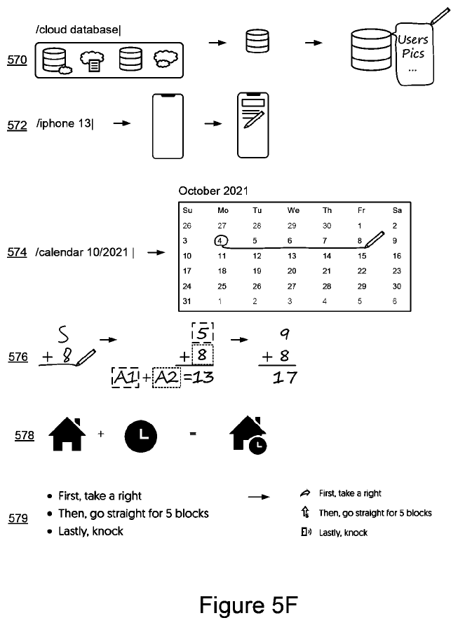

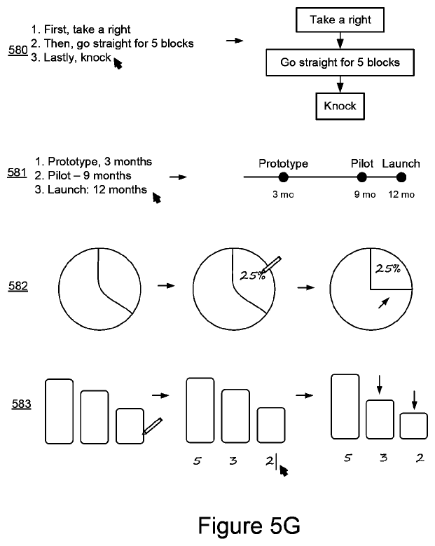

Since several of the content creation features of the document application 112, and more specifically the content predictor 118, are enhanced with predictive technology, the document application 112 can incorporate inputs provided by users to further improve and enhance the predictive models. In this way, the inputs provide feedback for the models so the models can “loop back” with more accurate and/or predictive results on a subsequent cycle, as discussed elsewhere herein. While some inputs may be explicit, others may be implicit or contextual, as discussed for example with reference to FIGS. 5A-5G.

In block 204, the document application 112 can detect inputs received via the input device 1214. If such input(s) are received in 204, the document application 112 may determine what types of input(s) were provided. For example, in block 206, the document application 112 may determine textual input(s) were received, which may be an input affecting a textual aspect of a document being curated in the document region of the interface. For example, textual input(s) may add, edit, format, delete, move, copy, paste, or otherwise manipulate text of the document. If the determine in block 206 is affirmative, the document application 112 processes the input(s) in block 208 in accordance with the content of the input(s) and update the document interface 210 to reflect the result of the processing (e.g., adding, editing formatting, deleting, moving, copying, pasting, or otherwise manipulating the text of the document).

By way of further example, the document application 112 may determine a first set of input(s) to be visualization design input(s) and process them accordingly, and then receive a second set of input(s), determine those to be visualization design inputs, and then predicting visualization object elements based on the first input(s) and the second input(s) and so forth.

In block 212, the document application 112 may determine visualization (e.g., design) input(s) were received and then, in block 214, the content predictor 118 may predict visualization objects element(s) based on the input(s) (e.g., a first input, a second input, subsequent inputs, etc.). The content predictor 118 may based its prediction on a plurality of inputs including but not limited to the input(s) received in 212/204. Non-limiting examples of inputs may include points, such as the points defining shapes, lines, and other geometric elements, positions, anchor points, and so forth; the timing at which points were received (e.g., reflect how quickly items were input, whether the user has hesitated, etc.); deleted points or items; context of other document content including other visualization objects and text in the document (e.g., content that is visible, content within a section of the document, content proximate to the inputs (e.g., between the margins and within a percentage of the visible area), proximity of similar content (other nearby visualization object elements), recency of the proximate similar content, etc.; the semantics of text (e.g., meaning, type, categories, emotion, etc.) other visualization object elements in the document; recording transcript semantics (e.g., meaning, type, categories, emotion, etc.); mathematical relationships between object elements, and so forth. Based on one or more combinations of these inputs, the content predictor 118 may generate predictive content (e.g., visualization objects, visualization object elements, attributes of the same, etc.), such as predictive shapes, words, charts, graphs, infographics, phrases, as well as dimensions and attributes for the foregoing, as discussed elsewhere herein.

FIG. 2B depicts a flowchart of an example method 214 for predicting visual objects (e.g., based on input(s)). In block 250, the content predictor 188 may determine an object element type based on the input(s). For example, the input(s) may reflect a series of points defining a shape or portion thereof, and the content predictor 188 may determine that the input(s) correspond to a shape. In another example, the input(s) may reflect a position in the document and include a textual input and the content predictor 188 may determine that the input(s) corresponding to a stylized textual object. In a further example, the input(s) may select an existing visualization object or element in the document and the content predictor 188 may determine that the input(s) correspond to the type of object or element selected. Numerous other variations are also possible and contemplated.

In block 252, the content predictor 118 may determine contextual inputs. In some embodiments, the content predictor 118 may determine proximate objects previously input by user and/or other context, such as the input(s) discussed elsewhere herein.

In block 254, the content predictor 118 may input data reflecting the visual object type, proximate objects, and/or other inputs or contextual data into one or more models, such as those discussed elsewhere herein. For instance, in some embodiments, the content predictor 1188 may determine a visualization object element type based on the input(s) and/or determine earlier-defined visualization object elements, such as those that might be proximate to the input(s), contextually related to the input(s), related to transcribed or defined text, or other sources (contextual inputs), and may provide the inputs, element type, and/or contextual inputs into the model(s) in block 254.

In block 255, the content predictor 118 may generate visual object predictions using model(s) and data input in block 254 and may determine predicated visualization object elements based on the predictions. In some cases, the content predictor 118 may generate first visualization object element predictions based on the visualization object element type and earlier-defined visualization object elements or may use another suitable variation such as those discussed elsewhere herein.

In some embodiments, the content predictor 118 in block 214 may determine a mathematical relationship between input(s) received from the user and mathematically associating a first set of first visualization object elements and a second set of visualization object elements based on the mathematical relationship, as discussed elsewhere herein. The content predictor 118 may then receive further input modifying an attribute of an element from the first visualization object element(s) and the second visualization object element(s) and compute an output (as the suggestion output used to update the interface) based on the mathematical association between the first visualization object element(s) and the second visualization object element(s), the output of which may be used to update the document interface (e.g., the result of a user-drawn equation, etc.).

In block 256, the content predictor 118 may filter the predictions based on a threshold (e.g., confidence threshold) and/or other filtering criteria.

Referring again to FIG. 2A, in block 216, the content predictor 118 may provide a suggestion for predicated visual object element(s) and the document application 112 (e.g., the text editor 114 and/or the graphics editor 116 as the case may be) in block 218 may update the document interface based on the predicted visual object element(s) (e.g., to include the one or more predicted first visualization object elements as one or more suggestions). In some embodiments, the document interface may be updated to automatically replace user-input element(s) with predicated object element(s), may be updated to visually suggest the predicted object element(s) (e.g., by aligning (e.g., overlaying, underlaying) the predicated object elements with the user-input element(s) and prompt the user to adopt the suggested element(s), and so forth. In some cases, the output of the filtering in block 256 may result in a filtered result set that includes predicted the visualization object elements of block 216.

In a further example, the content predictor 118, by predicting visualization object element(s) based on inputs(s) may predicting that the visualization object element(s) reflect one or more elements of a graph. The content predictor 118 may receive subsequent input(s) and determining that they include value(s) for the element(s) of the graph, and based on the value(s), updating the document interface to include suggested graphical element(s) having adjusted dimensional attribute(s) based on the value(s).

FIG. 2C depicts a flowchart of an example method 218 for updating a graphical user interface based on predicted visual objects. In block 260, the document application 112 may determine based on the input(s) whether a new visualization is being created. If so, the document application 112 may update the document interface to suggest a graphical object and/or an element for the graphical object. The document application 112 may additionally or alternatively update the document interface to suggest supplementing the graphical object or element (e.g., as an auto-complete, starting suggestion, replacement suggestion, etc.). In block 262, the document application 112 may determine if a current visualization is being supplemented, and if so, in block 264 may update the interface to supplement the visualization object or elements by suggesting additional objects/elements, replacement object/elements, reformatting existing objects/elements, and so forth. In block 266, the document application 112 may determine based on the input(s), that an object or element is being reformatted, and in block 268 may update the document interface with suggestions or updates to reformat existing graphical object(s)/element(s). In block 270, the document application 112 may determine based on the input(s) that an object or element is being replaced, and in block 272 may update the document interface with suggestions or updates for replacing existing graphical object(s)/element(s).

By way of further example, the document application may suggest adding a new object or supplementing, replacing or reformatting an existing element of the graphical object or an object using one or more predictive shapes, lines, dots, legends, titles, texts, shadows, colors, thicknesses, textures, fills, spacings, positionings, orderings, shadings, graphs, charts, tables, diagrams, infographics and/or drawings, etc.

In block 220, the document application 112 may determine confirmatory input(s) were received and then, in block 222, may determine if predicted object(s)/element(s) that were suggested in the document interface were accepted. If so, the document application 112 may update the document interface to adopt the predicted object(s)/element(s). Whether or not the suggestion was accepted, the content predictor 118, in block 226, may use the confirmatory input to further train the model to improve further predictions.

In block 228, the document application 112 may determine visualization (e.g., design) input(s) were received and then, in block 229, may process the comment input. Examples of comments that can be processed (using the multimodal commenting tool) are discussed in further detail elsewhere herein. It should be understood that any visualization design input provided during a commenting cycle may be processed by operations of the method 200, such as blocks 214, 216 and 218. This allows any annotative objects or elements to also be predictive and more efficient and easier to use.

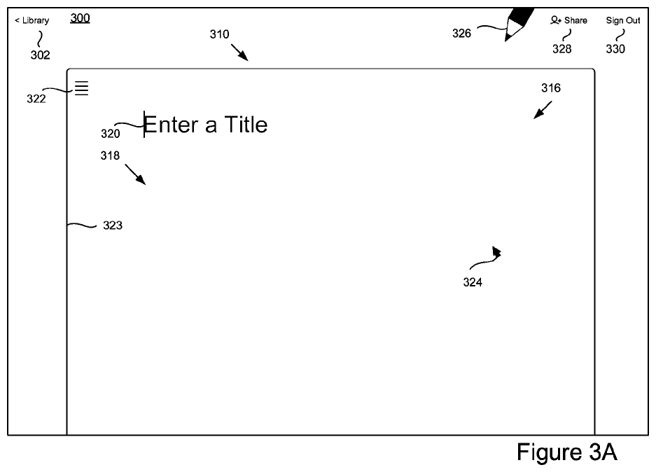

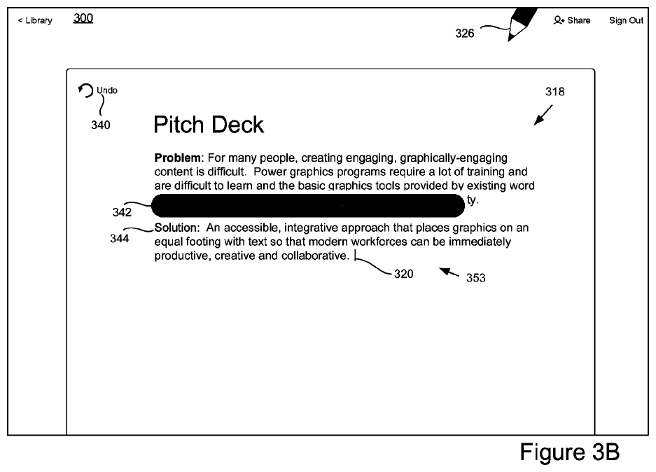

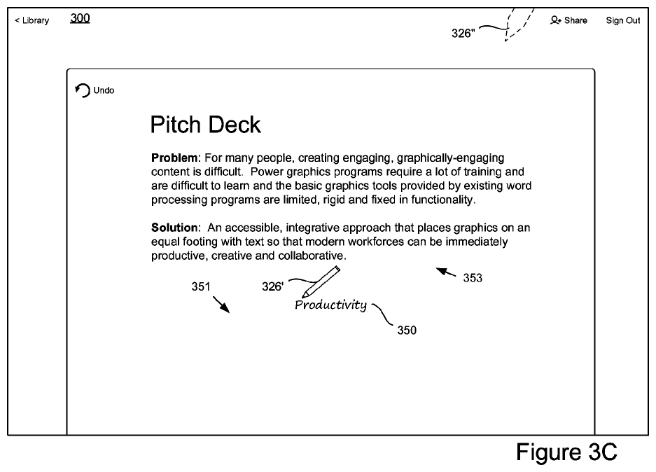

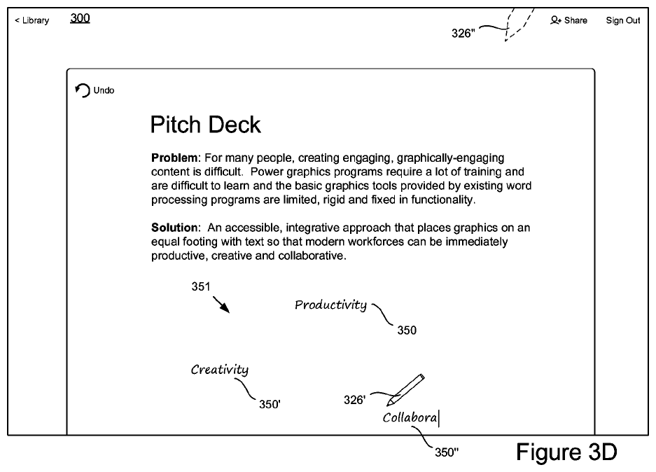

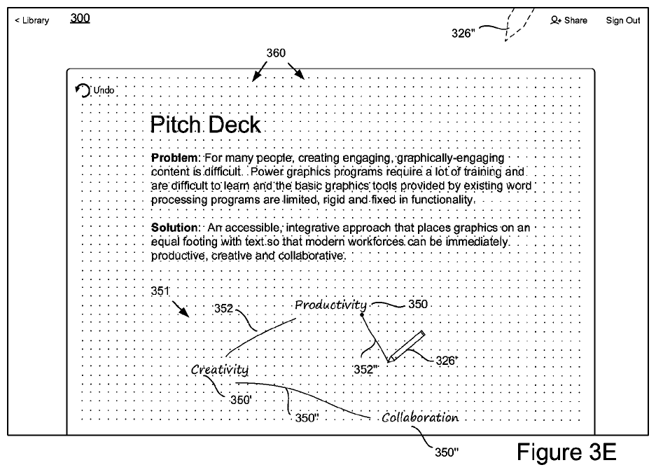

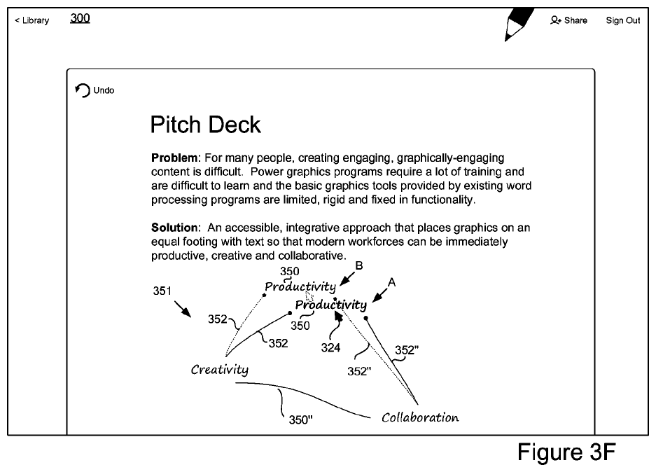

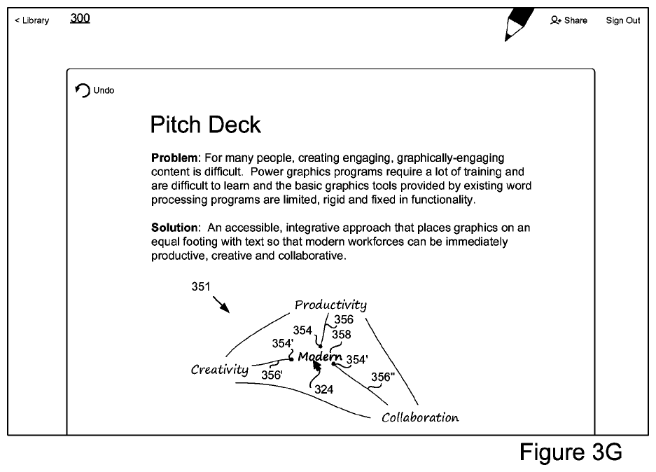

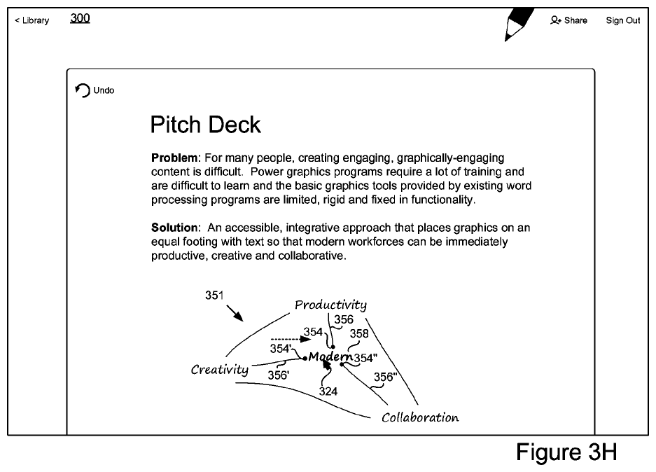

FIGS. 3A-3H depict aspects of an example graphical user interface 300 for graphically engaging content creation and collaboration. As shown, the interface 300 includes a user-selectable graphical element 302 for navigating to other interfaces of the document application 112. For example, the user-selectable element 302 may be an option for the user to select to navigate back to the user's document library, which may include links to any documents to which the user has access, such as documents the user has authored, documents the user has contributed on, documents the user has commented on, and so forth. As shown in FIG. 3A, the user may have selected to create a new document. The user may invite other users 102 to collaborate on and/or help author the document by selecting the user-selectable graphical element 328, which may be a share button, and the user-selectable graphical element 330 for signing out of the document application 112.

Responsive to selecting the user-selectable graphical element 328 using an input device of a computing device (e.g., user device 104), the document application 112 may receive the input and display an interface (e.g., a pop-up, modal, window, etc.) that includes graphical user interface elements for sharing the document with other users, such as text box for inputting identifying information about other users (e.g., email address), options for defining the level of access for the other users (e.g., review, edit, add, delete, etc.) such as checkboxes, and the completion element such as that button for finalizing the sharing request. Responsive to the selection of the completion element by the user via an input device the document application 112 may send a request to the other users sharing the document with them as users. If the other users are already registered users with the document application 112, then the document may appear those users' libraries be available upon those users accessing the document application 112. If not, users may be prompted to register with the document application 112 or may be provided anonymous access to the document. Other variations are also possible and contemplated.

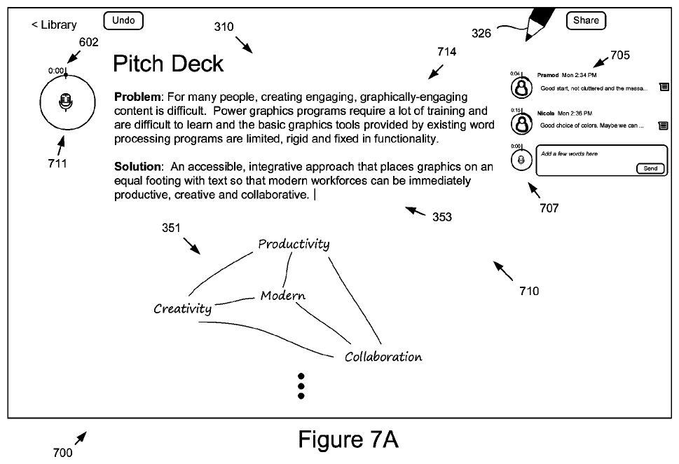

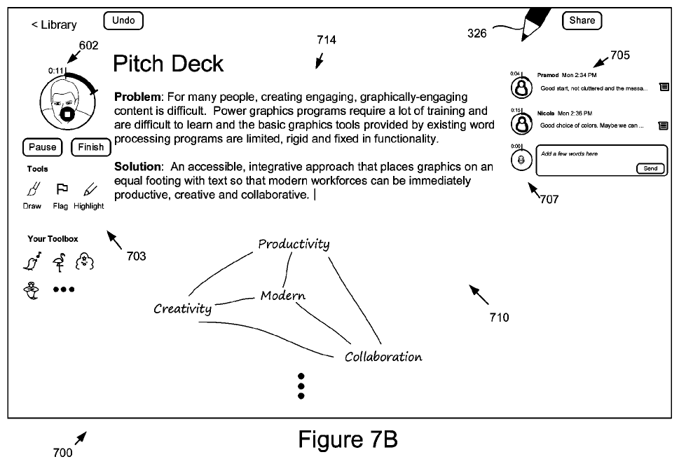

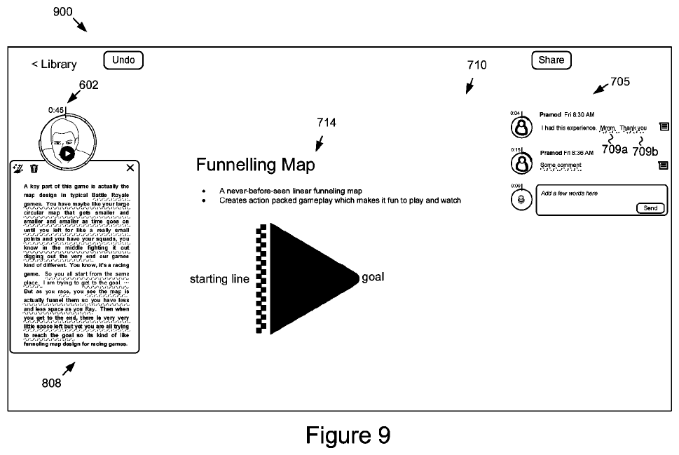

In some embodiments, the document interfaces disclosed herein, such as the interfaces 300, 700 (e.g., see FIG. 7A), and 900 (e.g., see FIG. 9A), may be rendered for display by the document application 112 executing on a user device 104 of a user 102. The document application 112 may execute in a browser, may be a native application installed and running on the client device of the user, or may take another form. As discussed elsewhere herein, in some embodiments, the document application 112 may be a distributed client-server application where one or more centralized instances executing on remote server(s) coordinate the inputs received from the user devices 104 of a multiplicity of users 102, such as users 102 collaborating around a document depicted in the interfaces 300, 700, 900, etc.

Referring again to FIGS. 3A-3H, the interface 300 may display a document 310 the document content region 316. The document may contain any suitable variation of content, as discussed elsewhere herein. In the depicted embodiment, the document may include a title content region 320 and any number of document portions 318 in the document content region 316. For instance, in FIG. 3B, the user is creating a document embodying a pitch deck that initially includes the written textual portion 353.

A document portion may comprise any suitable content, such as a paragraph, sentence, a word, phrase, any suitable visual content, and so forth. A user using an input device may use the interface to add, delete, edit, supplement, annotate pictorial and textual content of the document 310. For example, the user 102 may use an input device to select to add a title in the title content region 320 (e.g., Pitch Deck as depicted in FIG. 3B), and may select to add a description (e.g., the problem and solution paragraphs the depicted in FIG. 3B). In some embodiments, the interface may include persistently displayed menus and toolbars, or may utilize dynamically displayed menus and toolbars to de-clutter the experience. For instance, a menu 322 icon may be displayed which upon selection via an input device by a user 102, the document application 112 may display a graphical menu or toolbar, such as the toolbar 342 depicted in FIG. 3A. Further, the user 102 may, using an input device, hover over or otherwise place focus over (e.g., using cursor 324) a dedicated region of the interface 300, such as side region 323, in response to which, the document application 112 may the user-selectable multimodal commenting component 602 for adding comments for adjacent portions of the document, as discussed in detail elsewhere herein. It should be understood that any suitable variation of menus, toolbars, or other user-selectable user interface elements may be provided and utilized.

In some embodiments, as shown in FIG. 3B, the user 102 using input device may select a portion of content in the interface (e.g., highlight, draw a rectangle around, swipe, etc.), and depending on the selected portion, the document application 112 may responsively display corresponding user interface elements, such as menus and toolbars that the user may use to edit the selected portion. For example, if the selected portion is text, the text editor 114 of the document application 112 may display a text editing toolbar 342 which the user may use to edit the text (bold, italicize, strikethrough, underline, bracketize, format, bulletize, place quotes around, hyperlink, etc.). In another example, the user may select a visualization object or visualization object elements (e.g., shapes, lines, images, etc.) using an input device and the graphics editor 116 may display responsively a corresponding graphics-based editing toolbar (not shown) that the user can use to edit those elements (e.g., add, adjust, change, remove, etc., shapes, linewidths, fill, positioning, rotation, spacing, shading, shadowing, etc.). Many other suitable variations are also possible and contemplated. Using interface 300, the user can easily add, modify, or delete content from the document. For example, the user may continue the paragraph 344 by selecting to place the cursor 320 at the end of the paragraph continuing to type in text using an input device. Should the user 102 wish to undo any changes the user has made to the document 310, the user 102 may select an undo graphical user interface element 340 using the input device, and in response to such a selection, the text editor 114 or graphics editor 116, as the case may be, may undo the last input by removing it from the interface 300.

Advantageously, using the interface 300, a user 102 may easily add rich visualizations to the document. In the depicted embodiment, the interface 300 contains a powerful user-selectable visualization editing component 326 that can be used by the user to easily design visualizations. In this example, responsive to selecting the visualization editing component 326, the user may move a corresponding visualization editing component 326′ around the interface and use it to add, modify, delete, or otherwise edit visualization object elements. In the depicted embodiment, responsive to selecting the visualization editing component 326, a placeholder visualization editing component 326” is depicted showing that the visualization editing component 326′ is active. It should be understood that the acts and functionality of the visualization editing component 326, 326′, 326” (collectively also referred to as simply 326 for simplicity) may be embodied using other suitable graphical user interface elements which are also contemplated and encompassed hereby.

For example, in FIG. 3C, the user, using the visualization editing component 326, may begin creation of a visualization object 351 (also referred to simply as a visualization in some cases) by adding stylized text element 350 (e.g., by selecting the location of the text (e.g., clicking, tapping, etc., using an input device) in the interface 300 and then typing in the text (e.g., using a keyboard). Continuing to FIG. 3D, the user continues to create the visualization object 351 by adding other stylized text elements 350′ and 350” using the visualization editing component. In some embodiments, upon inputting a visualization object element such as element 350, the graphics editor 116 may signal the content predictor 118 to evaluate the input and provide predictive suggestions for other visualization object elements to include in the visualization, which the graphics editor 116 may present in the interface 300. For example, the content predictor 118 may automatically generate suggested anonyms, synonyms, like words, contrasting words, etc., which the graphics editor 116 may receive and present as options in the interface using user selectable graphical elements (e.g., text prompts, overlaid text, dropdowns, etc.). The user may interact with the suggested elements via an input device to adopt or reject the suggestions (e.g., pressing escape button or another dedicated input). Numerous additional non-limiting examples of visualization object suggests are discussed elsewhere herein.

In some embodiments, upon activating the visualization edition component, the graphics editor 116 may automatically display a grid pattern layer 360 in the document region 316, which the user may reference to more accurate input the visualization object elements. For example, using the input device and the visualization editing component, the user may input connector lines 352, 352′, 352” between the stylized text elements 350, 350′, and 350”. The graphics editor 116 may assist the user with the input by automatically snapping the endpoints of the connector lines to the grid. In other examples, the endpoints may not snap but the grid may just serve as a visual reference. In some embodiments, the user may toggle the grid on/off, or the grid may not be displayed by the graphics editor 116 depending on the configuration and user preferences.

Additionally or alternatively, the graphics editor 116 may automatically associate the ends of the lines 352, 352′, 352” with the stylized text elements 350, 350′, and 350”, which interconnects the elements and makes them easier to move and adjust. For example, as shown in FIG. 3F, the user may select to move stylized text element 350 upward and to the left, and the graphics editor 116 may automatically resize the connector lines accordingly since they are connected to/associated with the stylized text element 350.

In the further example depicted in FIG. 3G, the user may have added an additional stylized text element 358, and the content predictor 118 may have automatically suggested adding the connector lines 356, 356′, 356” to the user by presenting corresponding graphical elements in the interface for the user to accept. The connector lines may already be linked (e.g., as reflected by endpoints 354, 354′, and 354”) to the new stylized text element 358 and the other corresponding stylized text elements 350, 350′, and 350”. As such, the user may easily then make adjustments to the visualization object 351 because, based on the adjustments, any impacts may be identified, and corresponding adjustments may automatically be made. For example, as shown in the FIG. 3H, the user may select to move the stylized text object 358 to the right, and the connector lines 356, 356′, 356” may automatically be adjusted to accommodate the change, thus reducing the amount of work needed to configure the visualization object 351.

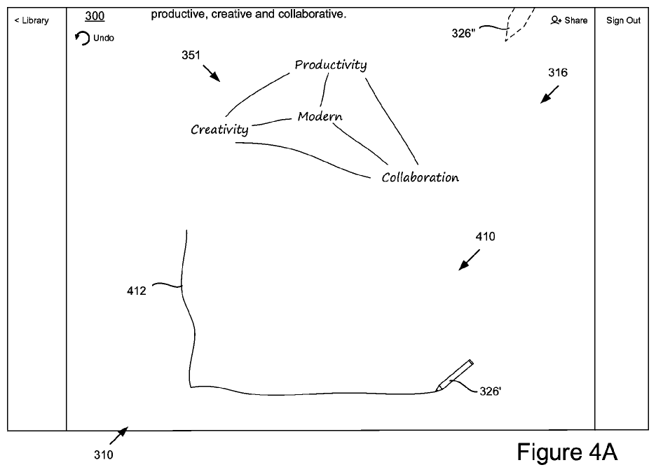

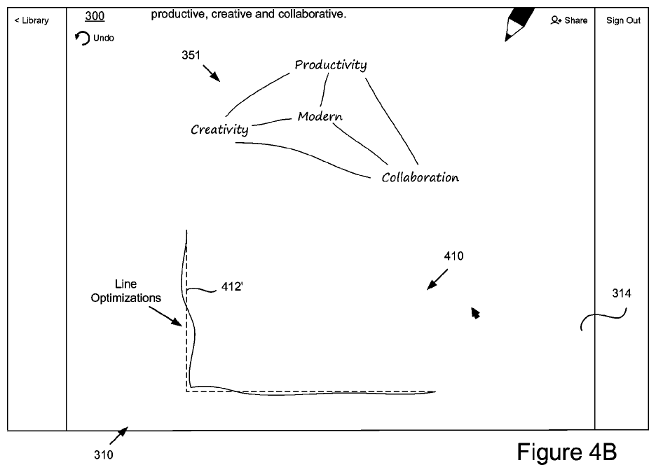

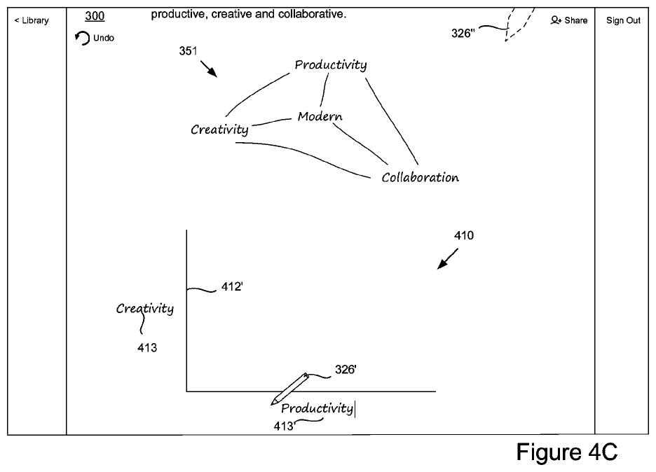

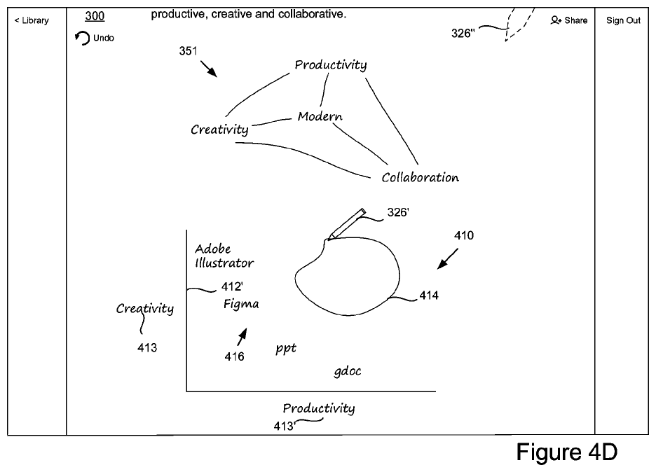

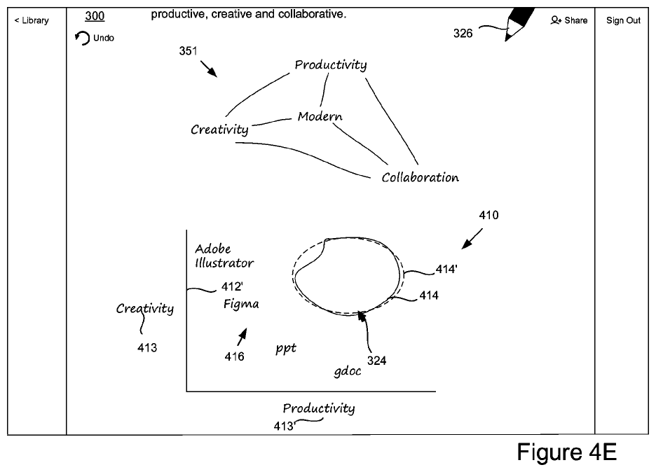

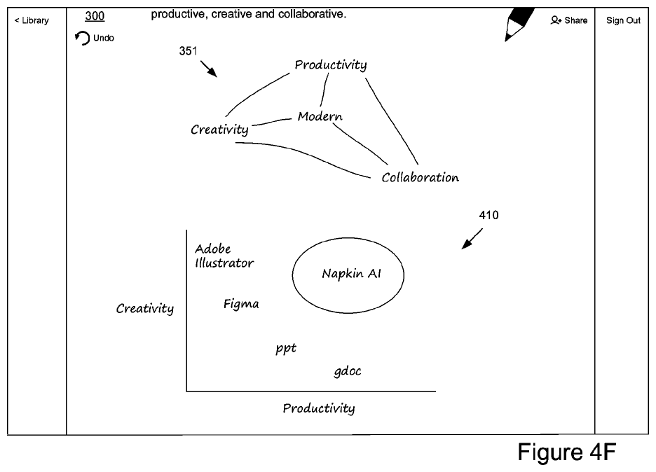

FIGS. 4A-4F depict further aspects of an example graphical user interface 300 for graphically engaging document 310 content creation collaboration. As shown, the user 102 using the visual editing component 326 and an input device, is inputting a new visualization object 410 by drawing an L-shaped line 412 in the document region 316 of the document 310. Responsive to receiving the visualization editing input, of the content predictor 118 of the document application 112 inputs the visualization editing input into a trained machine learning model which is configured to provide related content suggestions. This example, the machine learning model is configured to receive the drawing inputs made by the user to provide corresponding visual objects element suggestions that match what the user is drawing. The suggestions produced by the machine learning model are predictive of what the user is attempting to draw but are more precise and generally more aesthetically pleasing. As it can be difficult for the user to perfectly draw objects (e.g., a square, circle, straight lines, arcs, etc.) using an input device such as but not limited to a mouse or a touchscreen, the suggestion is provided by the content predictor 118 to help to speed up the design of the visualization object 410 while simultaneously making it more aesthetically pleasing.

The particular, as shown in FIG. 4B, a suggestion replacement element 412′ for the line drawn by the user 104 may be predicted by the content predictor 118 and rendered for presentation by the graphics editor 116. Responsive to the suggested replacement element 412′ been presented, the user may provide an input that selects the replacement element 412′ or rejects the suggestion (e.g., the user may click on the replacement element 412′ or selected cancel button or escape key to reject it).

Continuing to FIG. 4C, the user may further develop the visualization object 410 by including additional visualization object elements such as the stylized text entries 413 and 413′ using the visualization editing component 326. In some embodiments, the user may receive a further suggestion may have the content predictor 118 and the graphics editor 116 suggesting the creation of axis labels may overlay default text those regions (e.g., in the locations of 413 and 413′). In further embodiments, the user may manually have those elements.

Further, in FIGS. 4D and 4E, and creating a market comparison graph, the user may further input stylized text elements 416 and circle 414 indicating available space in the market using the visualization editing component 326. As shown, the user had difficulty drawing a round circle 414 using the input device, content predictor 118 was able to address the sufficiency by predicting the user was attempting to draw a circle and providing a suggested circular visualization object element 414′ as a replacement, which the design application 112 displayed in the interface in a position a corresponds to circle 414′ drawn by the user. This example, a graphics editor 116 use the existing position of the circle 414 drawn by the user to determine a position for the replacement visualization object element 414′. For instance, graphics editor 116, a center point of the circle 414 and the visualization object element 414′ and aligned them when providing the suggestion. Other variations for positioning suggested graphical elements may comprise using other dimensions, anchor points, feature attributes, contours, etc., that correspond between the element(s) input by the user and the predictive elements provided by the content predictor 118. In this example, the user selected to adopt the prediction using the cursor 324 and added an additional label to it as reflected in FIG. 4E.

FIGS. 5A-5G depict example AI-powered predictive visualization enhancements that can be generated by the content predictor 118. The content predictor 118 may comprise machine learning logic that is trained to determine visualization objects, visualization object elements, mathematical relationships between visualization objects, and/or visualization object attributes based on the visualization inputs provided by a user (e.g., using the visualization editor component 326). The content predictor 118 may comprise a plurality of models configured for the different use cases disclosed herein. Non-limiting example inputs that may be considered by content predictor 118 include points (shape points, anchor points, etc.), points timing and/or speed, context (text, images, other drawings), text semantics, and recording transcript semantics. The content predictor 118 may based suggestions it generates based on shape type, confidence, surrounding context, and historical confirmation, among other things. Based on one or more combinations of these inputs, the content predictor 118 may generate visualization objects, visualization object elements, text, dimensions, and/or other content discussed herein.

Non-limiting examples of machine learning models include convolutional neural networks, support vector machines, regression models, supervised learning algorithm and/or unsupervised learning algorithms, decision trees, bayes, nearest neighbor, k-means, and random forest models, dimensionality reduction models, gradient boosting algorithms or machines, image classifiers, natural language processors, and so forth. It should be understood that any suitable model capable of providing the AI-powered visualization suggestions disclosed herein may be used.

In some embodiments, the machine learning model(s) may provide confidence scores for the content recommendations provided by them, and the content predictor 118 may use various thresholds to filter out candidate recommendations that are unlikely to match the user's intention. Further, the content predictor 118 may scale the candidate recommendations dimensionally to correspond to the objects manually input by the user. This is beneficially as it allows the recommendations to be displayed in conjunction with the objects input by the user to demonstrate the efficacy of the recommendation and how it could be used. In other examples, the recommendations can be sized to reflect quantitative inputs provided by the user so that the user does not have to manually adjust the graphical elements to match. Numerous other variations are also possible and contemplated.

FIG. 5A depicts thirteen example AI visual auto-correct optimizations that can be produced by the content predictor 118 and provided for presentation by the document application 112 based on input provided via the visualization editor component 326 and the graphics editor 116. In optimization 501, the user has input 515 a rough oval shape and the content predictor 118 provided 516 an optimized oval element for presentation. In optimization 502, the user has input 515 a rough rectangular shape with irregular overlapping ends. The content predictor 118 is capable of providing 516 an accurate optimized rectangular element despite the user's inaccuracies in drawing the rectangle. In optimization 503, the user has input 515 a rectangular shape with wavy sides the content predictor 118 accurately predicted 516 an optimized rectangular element. In optimization 504, the user has input 515 an L-shape the content predictor 118 has predicted 516 an optimized version of the L shape. In optimization 505, the user has input 515 an arrow pointing at a circle (from left to right) and the content predictor 118 predicted 516 an optimized version for presentation. In optimization 506, user input 515 parallel lines (that are approximately parallel) and the content predictor 118 has predicted 516 corresponding optimized parallel lines. In optimization 507, user has input 515 two adjacent rectangles (that are approximately but not exactly the same size) and the content predictor 118 predicted 516 two adjacently situated rectangles presentation. In optimization 508, the user has drawn 515 an organizational chart element having one large bubble and two smaller bubbles connected with connecting lines and the content predictor 118 accurately predicted 516 an optimally sized, aesthetically correct version of the organizational chart element. In optimization 509, the user has drawn 515 a series of hashes and the content predictor 118 has provided 516 an optimized dashed arching line as a prediction. In optimization 510, the user has drawn a rectangle with roughly filled-in shading and the content predictor 118 is capable of determining that the scribbled line represented fill provided a filled-in, squarely oriented rectangle and provided 516 it as a suggestion.

FIG. 5B depicts three example AI visual auto-complete optimizations that be provided by the document application 112. In shape auto-complete optimization 511, the user began drawing a rectangle 511.1. The partial rectangle 511.1 was input into the content predictor 118. Based on this input, the content predictor 118 determined that the user was attempting to draw a rectangle and provided a suggested rectangularly-shaped visualization object element 511.2 for presentation to the user. Upon selecting to accept the suggested rectangularly shaped visualization object element 511.2, the graphics editor 116 replaced the user in-drawn rectangle 511.1 with the suggested rectangularly shaped visualization object element 511.2. As shown, the replacement rectangle 511.2 is smoothly shaped and has square corners whereas the hand-drawn version 511.1 has uneven sides and is less accurate.

In shape auto-suggestion optimization 512, the user began drawing a parallelogram 512.1. Based on this partial input, the content predictor 118 determined that the user was attempting to draw a parallelogram I provided the complete parallelogram 512.2 as a suggestion for the user to adopt. Upon selecting to adopt the suggested parallelogram 512.2, the graphics editor 116 replaced the user-drawn version with an optimized parallelogram 512.3, having straight sides and correct angles.

In repetition auto-complete optimization 513, the user began drawing a first circle 513.1, and the content predictor 118 predicted that the user was drawing a circle and provided a suggested circle 513.2 for adoption by the user, which the user accepted. The user and motion to input a subsequence shape and the content predictor 118 predicted that the user was attempting to draw a second circle that matches the previously adopted circle 513.3 and provided a second optimized circle suggestion 513.4 for presentation, which the user adopted as circle 513.5.

FIG. 5C depicts four example AI visual auto-format optimizations that can be provided by the document application 112. In the image anchoring auto-format optimization 514, the document contains two images, 514.1 and 514.2. Image 514.1 includes an annotation bounding the picture of the bear. Using the cursor 324, the user can reposition the image 514.1 including the annotation bounding the picture of the bear without affecting the annotation (keeping its position relative to the bear intact). In this example, the graphics editor 116 has anchored the annotation bounding picture of the bear based on the position of the annotation relative to a reference point of the image (e.g., a side) and preserved that relative position when the image 514.1 was repositioned.

In the text-anchoring auto-format optimization 521, the user has input a paragraph of text 521.3 using the text editor 114, and then drew a rectangle 521.1 around the word “animals” using the visualization editor component 326. The user then added additional text, i.e., “big appetites”, which resulted in the word animal shifting its position within the sentence and the document. The graphics editor, having anchored the rectangle to the word animal, automatically moved the rectangle 521.1 to the new position so it remains bounding the word “animals”.

In the text re-anchoring auto-format optimization 522, the user has input a paragraph of text 522.2 using the text editor 114, and then drew a rectangle 522.1 around the word “animals” using the visualization editor component 326. Subsequently, the user decided to move the rectangle to a different word in the paragraph 522.2, i.e., “ferociousness”. Upon being moved to the different word, graphics editor 116 dynamically re-associated the rectangle 522.1 with the new word, automatically determining the size of the new word relative to the size of the rectangle 522.1, resized the rectangle 522.1 so that it fit around the word “ferociousness”.

In touchup auto-format optimization 523, the user has input a phrase 523.1 and use of the visualization editor component 326 to underline the words “animals and truly social”. The content predictor 118 received the drawing input and determined based on the textual context and the placement of the input that the user intended to draw straight line underneath the words “animals and truly social”. Responsive to this determination, the graphics editor 116 may automatically replace the user-drawn line 523.2 with the optimized line 523.3, or may provide as a suggestion that may be adopted by the user as discussed elsewhere herein.

In auto-wrapping optimization 524, the user has written the phrase 524.2, i.e., “lions are great”, and bounded the phrase with a rectangle 524.1. Then, the user decided to add to the phrase 524.2 by adding the words “and I love them”, forming a revised phrase 524.3 that is considerably longer than the initial phrase 524.2. The content predictor 118, having received the foregoing inputs, determined that the user intended to have the rectangle 524.1 continue to bound the phrase, and as such, dynamically recommended an elongated rectangle 524.1′. In some embodiments, the elongated rectangle may automatically be updated by the graphics editor 116 to fully bound the phrase 524.3 or may be provided as suggestion for adoption by the user as discussed elsewhere herein.

FIG. 5D depicts five additional example AI visual auto-format optimizations that can be provided by the document application 112. In smart grouping auto-format optimization 541, the user has drawn a customized graphic 541.2 using the visualization editing component 326 to highlight the word “communities” in a previously input phrase 541.1. The user then added a hard return to the phrase after the word “animals” which then moved the word communities to the next line in the document. The graphics editor 116, having dynamically detected that the word “communities” had moved, and having anchored the custom graphic to the word communities, graphics editor can automatically move the custom graphic 541.2 to a new location so it continues to highlight the word “communities” as it was before.

In node interaction auto-format optimization 542, the user has drawn diagram 542.1 having a square, two circles, and interconnecting lines between them. Then, using the cursor 324, the user adjusted the positioning of one of the circles inward. The graphics editor 116 dynamically adapted the interconnecting lines between the repositioned circle and the other elements of the diagram so the user did not have to manually make adjustments as depicted in the revised diagram 542.2. The user again readjusted the position of that circle downward and outward, and again, the graphics editor 116 dynamically adapted the interconnecting lines such that the user didn't have to manually make those adjustments as shown in further revised diagram 542.3.

In the hierarchy auto-format optimization 543, the content predictor 118 may receive, as input, hand-drawn hierarchy diagram 543.1 input by the user using the visualization editing component 326, based on the contents of the diagram, may determine the diagram type in automatically format the respective elements based on their positioning within the diagram, and provided that as the suggestion or replacement socialization object 543.2.

In the smart eraser auto-format optimization 544, the user may draw the drawing 544.1 using the visualization editing component 326, select an eraser component 550 (e.g., using a corresponding user-selectable interface element), and then erase a line inside one of the circles of the drawing 544.1. The content predictor 118, based on the foregoing inputs and the constituent elements of the drawing 544.1, may detect that the object being erased is bound by another object, in this case a circle, and may limit erasure of the content selected by the eraser component 550 up to the boundary of that circle, thus resulting in a modified drawing 544.2.

In auto-format optimization 545, the user may draw a check mark 545.1 using the visualization editing component 326, and the document application 112 may predict that the user intended to draw a properly formed checkmark and provide such an object 545.2 for presentation. Upon adopting the suggestion, the document application 112 may animate the adopted suggested object 545.2 by playing back the animation 545.3.

FIG. 5E depicts an example AI chart optimization that can be provided by the document application 112. Then optimization 560, the user may draw the chart 561.1 using the visualization editing component 326. Content predictor 118 may predict the type of chart that the user was attempting to draw and may automatically format and edit the constituent elements of the chart as reflected by object 561.2, which may be provided as a suggestion or replacement as discussed elsewhere herein.

FIG. 5F depicts several AI graphical enhancements that can be provided by the document application 112. For command 570, the user may write/cloud database, and the content predictor 118 based on the input may determine that a content command was provided based on the “/” and generate and provide one or more suggested graphics that correspond to the word “cloud database”. The user may select one of suggested graphics and then further resize and annotate the graphic with the visualization editing component 326 as discussed elsewhere herein.

For command 572, the user may write/iphone 13, the content predictor 118, based on the input, may determine that a content command was provided based on the “/” and generate and provide one more suggested graphics that correspond to the word “iphone 13”. The user may select one of suggested graphics and then further resize and annotate the graphic with the visualization editing component 326 as discussed elsewhere herein.

For command 574, the user may write/calendar and some date (e.g., 10/2021), based on the input, the content predictor 118 may determine the content command was provided based on the “4/” and generate and provide a calendar graphic suggestion. The user may accept and then further resize and annotate the using the visualization editing component 326. For any of 570, 572, and 574, the user may use any of the functionality described herein to further modify and/or adapt suggestion graphic (e.g., resize, color, shade, filled, further annotate, remove aspects, etc.).

For enhancement 576, the user, using the visualization editing component 326, may write a formula, such as a simple addition equation. Based on the input, the content predictor 118 may identify that equation was drawn, may identify the numbers, variables, symbols, and other elements of the equation, and generate and provide an answer to the equation (or if the answer was already provided, may verify the answer of the equation provide any corrections). Further, if the user modifies an aspect of the equation, the content predictor 118 can detect the change and update the corresponding mathematical logic as well as the answer, as shown in FIG. 5F.

For enhancement 578, the user may input a series of graphics, and the content predictor 118 may automatically combine the graphics together to form a combined graphic to provide that for suggestion or replacement to the user.

For enhancement 579, the user may input a series of bulleted textual items. Based on the content of the bulleted items, the content predictor 118 may determine a sequence or relationship between the bulleted items may generate a corresponding visualization that illustrates the sequence or relationship and graphically represents each item. For instance, the bulleted list may be a list of directions and the suggested visualization object may comprise a diagram illustrating the directions.

FIG. 5G depicts several further AI graphical enhancements that can be provided by the document application 112. For enhancement 580, the user may input a numerical list of items. Based on the content of the list of items, the content predictor 118 may determine that there are sequential may automatically generate a flow diagram including sequential interconnected elements for the items.

For enhancement 581, the user may input a numerical list of items that include dates. Based on the content listen items and the fact that dates were included, the content predictor 118 may determine a time sequence to the items and generate a corresponding visualization object representing that time sequence, such as the timeline depicted in FIG. 5G.

For enhancement 582, the user using the visualization editing component 326 may draw a pie chart including two slices may input a percentage inside one of the slices. As shown, the user input 25% inside one of the slices but the slice represented a greater proportion than 25%. Instead of requiring the user to go and edit the pie chart, the content predictor 118 may automatically identify the drawing as a pie chart, the constituent slices, and the 25% drawn by the user, and then suggest an optimized pie charted with the two slices appropriately sized based on the 25% input by the user.

For enhancement 583, the user using the visualization editing component 326 may draw a bar chart with three vertical bars. Then, underneath the bars, the user may draw the numerical values corresponding to the bars (e.g., five, three, two). Responsive to receiving these inputs, the content predictor 118 may automatically determine that the length of the bars is not proportional to the values input by the user provide suggested visualization object that automatically resizes the bars to be proportional to the values input by the user.

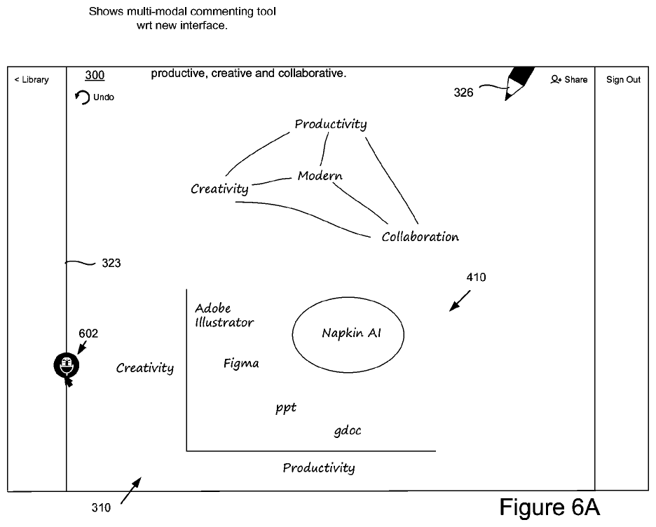

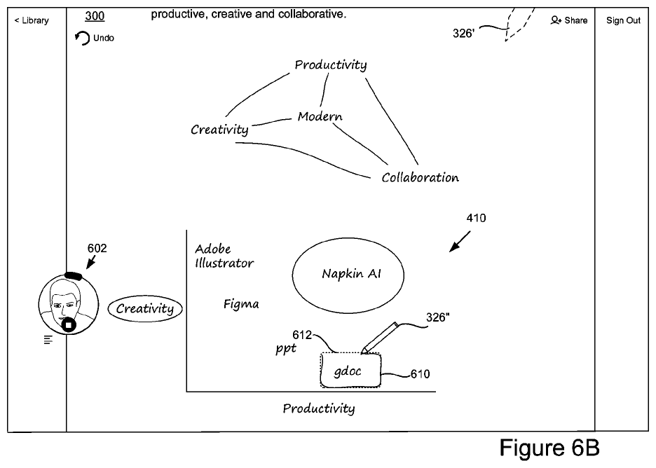

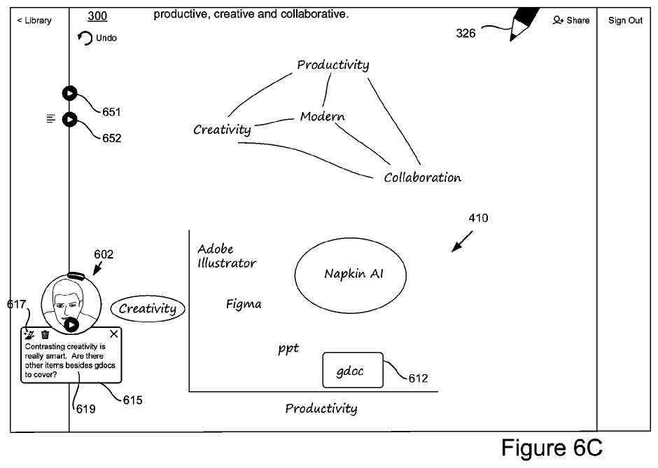

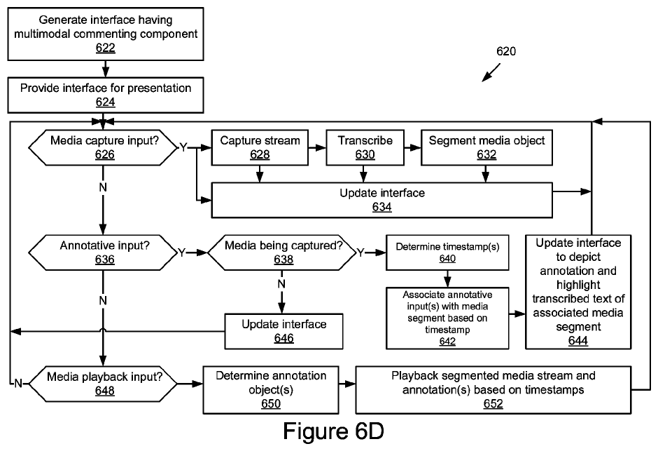

FIGS. 6A-6C depict aspects of an example graphical user interface showing AI-powered multimodal commenting functionality. As shown in FIG. 6A, responsive to the user focusing (e.g., hovering, tapping, gesturing, etc.) over the side 323 of the document 310, the document application 112 may display the multimodal commenting component 602. The user may select the multimodal commenting component 602 to capture a comment for the document (typically for the content positioned adjacently such as the visualization object 410 in this case). In a further example, by repositioning the cursor 324 higher or lower in the document along the side 323, document application 112 may reposition the multimodal, then component 602 based on the position of the cursor 324 such that position of any comment made with the multimodal commenting component 602 may be adjusted. Further, an earlier-made comment may be dragged to a different position in the document if it was inadvertently created in the wrong place where had changed since it was initially made and that references a different portion of the document. Numerous other variations are also possible and contemplated.

Responsive to selecting the multimodal commenting component 602, the multimodal commenting component 602 may transition to showing a media stream of the user (captured using an image sensor of the computing device 104 associated with the user 102) along with a red graphical element for stopping the recording as shown in FIG. 6B. During capture of the recording, the user may use a whiteboard functionality of the document application 112 to provide feedback on the document and/or the adjacent document portion, such as the visualization object 410. For instance, as shown, the user may use the visualization editing component 326” to draw on the visualization object 410 (e.g., circle word creativity and a box around word gdoc). Any functionality associated with the visualization editing component 326 discussed elsewhere herein is also applicable to comments that the user may make using the multimodal commenting component 602. For example, while drawing the box 610, the content predictor 118 generate and produce a visualization object element suggestion 512 (an optimized box with straight side and square corners) and graphics editor 116 may update the interface 300 to include the suggestion 612, which the user 102 may adopt by selecting it using the cursor as shown in FIG. 6C. The multimodal commenting tool 120 automatically associates the annotative elements added by the user with the times during the recording at which they were input. This allows the annotative elements to be associated with the verbal thoughts articulated by the user. Textual highlighting components 619 may be displayed in the transcription region 615 indicating the thoughts with which the annotative elements are associated, as discussed further elsewhere herein.

As the user is speaking, the document application 112 dynamically transcribes the audio into words using a transcription engine and updates the transcription region with the transcribed words and sentences. The transcription engine used by the document application 112 may comprise any suitable first or third-party transcription engine capable of transcribing captured audio into text (e.g., using speed-to-text APIs offered by Microsoft, Google, Amazon, Nuance, proprietary speech-to-text software, etc.). As shown, a transcription region (e.g., text box) including a textual transcription of the recording to be shown or hidden using multimodal commenting component. The transcription may be automatically generated by the multimodal commenting tool 120 has a recording is being captured and a transcription text may be populated into the transcription region 615 contemporaneously (e.g., in real time). In some cases, the transcribed text may include nonsensical text, such as gibberish words, word fragments, placeholder words and sounds (e.g., hmmm and mmm, uh, etc.), sentence fragments, incorrectly transcribed words, etc.). The multimodal commenting tool 120 may include a cleanup function (e.g., responsive to the selection of cleanup element 617, automatically, etc.), that is capable of cleaning up the transcribed text using natural language processing. The natural language processing may remove the nonsensical text, gibberish words, word fragments, placeholder words and sounds, and so forth, and may misspelled words, out of context words, incorrect phraseology, and other defects to clean up the transcription. As such words are removed from the transcription region, the multimodal commenting tool 120 may automatically remove the corresponding media segments from the media object such that upon playback none of the nonsensical portions of the media object and/or transcription will be played back.

The comment, once captured, may be played back using the multimodal commenting component 602, which in this view has transitioned from the red recording perspective to the blue playback perspective, in which the corresponding blue scrubbing region may be used to scrub between the beginning and end of the recording in the blue play button may be selected to initiate playback of the recording. It is noted that on playback of a presenting or authoring user's message and/or a commenting user's comment, the document application 112 may render the playback video in any suitable location, including in the recording dial video region, in a region overlaid on the active content region, in a movable and/or resizable region, and/or any other suitable location and/or size.

As shown in the interface 300 and FIG. 6C, in this example to other previously captured comments 651 and 652 are available for review. On selection of the icons representing the comments 651 and 652, corresponding multi modal commenting components may be displayed such that the user can consume the recording and view the transcription.

FIG. 6D depicts a flowchart of an example method 620 for providing multimodal comments.

In block 622, the document application 112 generates a document interface including a document content region. In some embodiments, the document interface may also include a multimodal commenting tool that is user-selectable to input multimodal comments. In block 624, the document application 112 may provide the document interface (e.g., the interfaces 300, 700, 900, etc.) for presentation to users 102.

In blocks 626, 636, and 648, the document application 112 may determine what input type was received whether it matches the respective criteria of those blocks. If not, the method may await further input before processing, or may return to other methods (e.g., 200) to perform other operations, etc.

It should be understood that the method 620 or operations thereof may be combined with compatible methods or operations of FIGS. 2A-2C (200, 214, 218, etc.) and/or other operations, acts and/or functionality described herein, and that those combined and/or hybrid methods are contemplated and encompassed hereby.

In block 626 in particular, if it is determined that the input is a media capture input, such as a record input received via the multimodal commenting component 602, the multimodal commenting tool 120 may capture a media stream in block 628, transcribe the media stream to text in block 630 and segment the media stream into a segmented media stream object based on the transcribed text. Each segment of the segmented media object may correspond to a phrase (of one or more words, etc.) in the transcribed text. In parallel with or sequential to any of the blocks 628, 630, and/or 632, the multimodal commenting tool may update the interface to reflect progress, such as playback the captured media object as it is being captured, display transcription output in a transcription region of the document interface as it is being produced, and display the evolving media segments based on the transcription output, and so forth. In some embodiments, in response to receiving an input to capture a media stream via a media capture device in association with a document, the multimodal commenting component 602 may be updated to providing a media player configured to playback the segmented media stream object.

In block 636, if it is determined that the input are annotative input(s), the document application 112 may determine if a multimedia stream is being captured. If not, the document application 112 may process the annotative input(s) as visualization design input(s) as discussed with reference to FIGS. 2A-2C. In some embodiments, the annotative input(s) may be intended to add to, revise or delete the actual content of the document and may be processed accordingly.

In block 638, if media is being captured, the multimodal commenting tool 120 may determine a timestamp(s) in block 640 for the annotative input(s), and in block 642, may associate the annotative input(s)/visualization object(s)/element(s) created based on the annotative input(s) with the timestamp(s) as well as associate the media segment(s) with the timestamp(s) and/or visualization object(s)/element(s), and so forth. In block 644, the multimodal commenting tool 120 may update the document interface to depict the results of the annotative input and highlight any aspects of the transcribed text associated with the media segments as applicable.

By way of example, the document applicant 112 may generate a document interface including a document region and a multimodal commenting component having a transcription region configured to display the transcribed text and the media player, may provide the document interface for presentation via an input device of a computing device associated with a user. Then, while capturing a media stream, the multimodal commenting component may play back the media stream in the media player and contemporaneously update the transcription region with the transcribed text. The multimodal commenting tool 120 may segment the media object based on the transcribed text, which may include, by way of example, determining two or more sequential phrases comprised by the transcribed text and tagging the media object with two or more timestamps corresponding to the two or more sequential phrases.

In a further example, the multimodal commenting tool 120 may receive an annotation input defining an annotative visualization object having one or more visualization object elements while the media stream is being captured. The multimodal commenting tool 120 may determine an annotation timestamp based on a media stream playback time and store an annotative visualization object in association with the document. In this case, the annotative visualization object may include the segmented media object, the one or more visualization object elements (which may be processed by the graphics editor 116 and/or the content predictor 118), and the timestamp. The document application 112 may update the document interface to depict the annotative visualization object.

In block 648, the multimodal commenting tool 120 may receive a media playback input in block 648, in response to which the multimodal commenting tool 120 may determine in block 650 one or more annotation objects associated with the media playback input (each of which may include an annotation timestamp, play back the segmented media stream object via the media player), and in block 652 the multimodal commenting tool 120 may provide the one or more annotation objects for presentation in association with the playing back of the segmented media stream object based on the annotation timestamp of each of the one or more annotation objects.

In some embodiments, the annotative input(s) may be intended to be a commentary on the content and may highlight and annotate the content but no necessarily modify the content, in which case it may be formatted an aligned with the document content in a way that makes it apparent that it is commentary in nature. In some instances, while not shown, the multimodal commenting component 602 may include a graphical element, or the user may provide a dedicated input (hold a key board key that toggles the functionality, selects a dedicated mouse button, uses a certain gesture, etc.) to select whether the annotative input(s) are commentary or revisionist (adds to, revises, or deletes the content).

FIG. 7A depicts a graphical user interface 700 for creating, editing and/or collaborating on a document 310. The interface 700 includes the multimodal commenting component 602, a document region 710 depicting a portion 714 of the document 310, and a commenting region 705.

The multimodal commenting component 602 uniquely provides users with the ability to easily express their thoughts about aspects of the portion 714 of the document depicted in the document region 714.

In some embodiments, a user may curate (add, edit, review, revise, etc.) document content in the document application 112 itself using interface elements included in the user interface 700.

For instance, the interface 700 may include functionality to add headings, text, AI-driven visualizations, pages/blocks, images, and other content via available interface elements, such as document toolbars, buttons, icons, content regions, etc. In further embodiments, the user may use both external and native authoring tools to iteratively author/edit the document. Other variations are also possible and contemplated.

In this example, a user has created a document embodying a pitch deck which includes the written textual section 353 and the AI-assisted graphical visualization object 351. Other users 102, using the multi-modal commenting component 602, may leave multimodal comments about the document or various different aspects of the document. In this embodiment, the document application 112 may include a persistent graphical element 711 in the interface, such as the microphone icon and associated element, which may be selected by an input device of the user device 104 to trigger capture of the user's 102 comment. In some embodiments, the user may select a region of the document with an input device (e.g., using rectangular select tool, swiping and highlight text and/or graphics, etc.) to identify the specific content about which the user may desire to make a comment using the multimodal commenting component 602. In further embodiments, the user may drag the graphical element 711 of the multimodal commenting component 602 to an area adjacent to a relevant portion of the document 310 about which the user desires to make a comment and the document application 112 may, based on this input, associate the comment with the adjacent portion of the document 310. In further embodiments, inputs provided by the user using the input device of the user device 104 may be used to associate the comment with the relevant corresponding portions of the document 310. Other variations are also possible and contemplated, as discussed elsewhere herein.

The multimodal commenting component 602 uniquely provides a user the ability to dynamically add comments to an active page or portion of the document depicted in the document region 710. Advantageously, using the multimodal commenting component 602, a user may capture media (audio, audiovisual, etc.) messages about the active portion, and the document application 112 may automatically perform a speech to text conversion of (transcribe) the captured message in real time and display the converted text in a transcription region of the multimodal commenting component 602. In some embodiments, the captured message and transcription may be stored in a data store in association with the user and the document for access and retrieval as necessary.

Further, using the document application 112, the user may immediately revisit the captured message, reorder the message segments comprising the message, delete one or more of the message segments, quickly scrub through the message segments in any suitable order, etc., as discussed further herein. Beneficially, as users use the provided media editing functionality to remove segments, insert segments, and re-order segments, the document application 112 can automatically create a new media object (e.g., video) for playback by the user. In some embodiments, responsive to the media object being edited by the user, the document application 112 generates the new media object by updating the metadata associated with the media segments to reorder the segments, and upon playback, the media player transitions between the (often non-sequential) segments based on the metadata to provide the user with a contiguous playback experience. In other embodiments, the document application 112 may generate a new media object (e.g., server-side using an asynchronous task to optimize delivery). To enhance quality, the document application 112 may add transitional elements and video enhancements to remove undesired jump artifacts in the video and/or audio due lack of consistency between segments. For instance, the document application 112 can automatically morph the end of a video clip to the beginning of the next one, and so forth. Other variations for creating the new media object are also possible and contemplated.

Simultaneously with recording messages, the user may use various annotation tools provided by the multimodal commenting component 602 to annotate the content in the active portion of the document depicted in the document region 710, as discussed in further detail elsewhere herein. The document application 112 may correlate the annotation(s) with the specific message segments made by the user(s) at the time the user(s) input the annotation(s) and store the correlations in a data store in association with the document for later access and/or retrieval. This whiteboard-like functionality advantageously provides the user with effective way to further express his or her thoughts about the active portion of the document. FIG. 7B depicts example annotation toolbar 703 having various features that can be used by a user to annotate the content in the document region 710 while recording a message, such as drawing, flagging, and highlighting tools, as well as tools for adding icons, graphics, memes, or any other descriptive annotative content. It should be understood that in further embodiments, annotations may be additionally or alternatively made using the visualization editing component 326 using the acts and functionality discussed elsewhere herein.

Referring again to FIGS. 7A and 7B, in addition to a main message that can be recorded using the multimodal commenting component 602 on the left side of the interface 700, other users can leave separate comments in the commenting region 705 on the right side of the interface 700 using other instances of the multimodal commenting tool. A user can create a new instance of the multimodal commenting tool by simply recording a messaging in the new comment section of the commenting region 705. Beneficially, the same powerful features of the multimodal commenting component 602, including providing supplemental annotations in the content region, are available to users leaving comments in the commenting region 705. When such a comment is played back (e.g., by selecting a corresponding play button or video region of that comment), any annotations made by that user during the comment will be rendered at the appropriates times during playback of the comment. It should be understood that the particular layout and positioning of the elements 602, 710, 705, etc., can vary and that other variations of the interface situating these elements in different positions are possible and contemplated, such as but not limited to the layout depicted in FIGS. 6A-6C. For instance, in some embodiments, the elements 602 and 705 may be combined on the same side of the interface, may be overlaid on the document, may be situated above and below, may be dynamically shown and hidden based on input, may be depicted using different formats and graphical elements, etc.

In some embodiments, one or more presenting users may use the multimodal commenting component 602 and/or the visualization editing component 326 to present segments of a document to other users with which the document has been shared. The other users can, using the commenting functionality of the commenting region 705 and/or visualization editing component 326 to leave comments regarding the presented segments. The comments may be textual comments using a corresponding text box and/or may comprise video comments, transcribed text, document edits, and/or annotations as discussed elsewhere herein. For example, two or more commenting users may collaborate using instances of multimodal commenting component 602 in the commenting region 705, as shown in FIGS. 6A-6C or using another suitable interface layout. For example, a first user may make a comment using an instance of the multimodal commenting tool (e.g., 602, 707, etc.), may revise their comments (delete and/or reorganize passages of the recorded comment, supplement by recording additional thoughts, etc.), and a second user may respond to the first user's comments by leaving corresponding comments using an instance of the multimodal commenting tool (e.g., 602, 707, etc.). Based on the collaboration, the presenting, first, and/or second user may then edit the underlying content of the document based on the collaboration, and so forth.

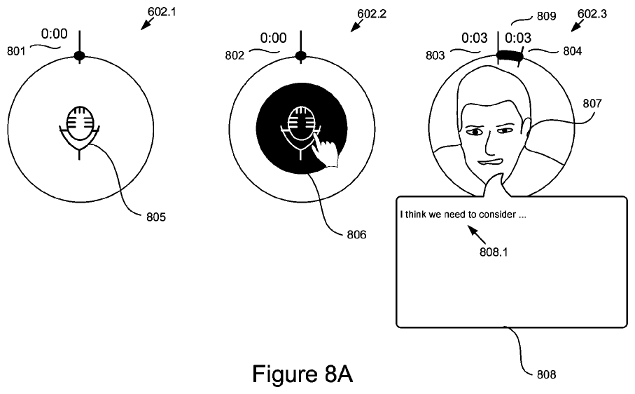

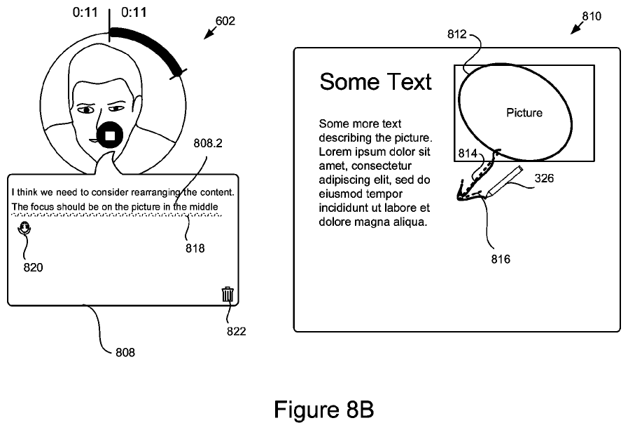

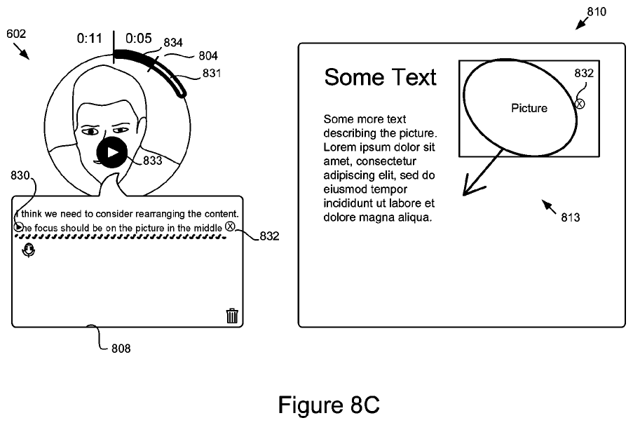

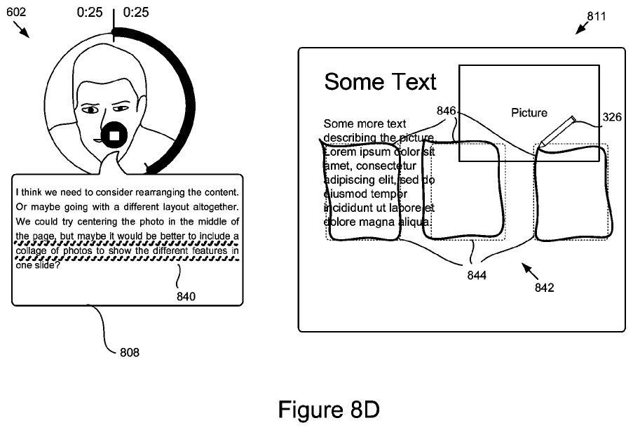

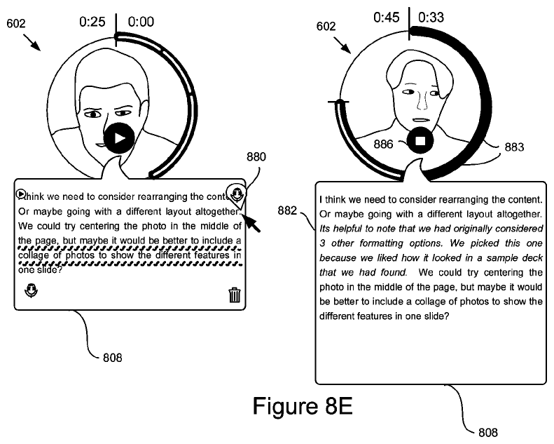

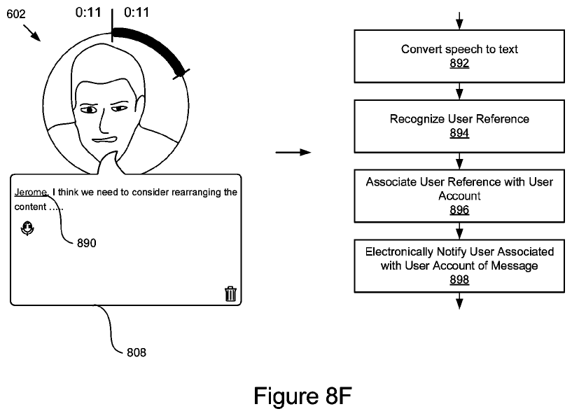

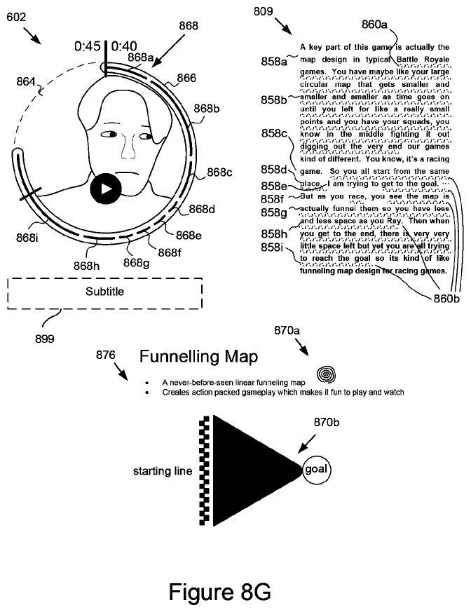

FIGS. 8A-8G illustrate further aspects of the multimodal commenting component 602 as it relates to the active content of the document. In particular, in FIG. 2A, a user desiring to record a message about the active portion of the depicted document begins by selecting a corresponding graphical recording element, in this case a microphone icon 805 shown in the first and second perspectives 801 and 801 of the multimodal commenting component 602, to initialize recording of the message. Responsive to receiving the input to begin recording, the document application 112 may initialize an audio capture device (e.g., microphone) of the user's user device and/or an image capture device (e.g., webcam, forward-facing camera, etc.) of the user's user device (e.g., laptop, tablet, mobile phone, etc., and may begin capturing a media stream (e.g., audio and/or video) of the user, which may be depicted in a playback region 807 of the multimodal commenting component 602. The user may then vocally articulate the message 808.1 (e.g., “I think we need to consider . . . ), the transcription of which is shown in the transcription region 808. As the recording progresses, the multimodal commenting component 602 may update a graphical progress bar 804 (e.g., shown in red) and a time region 809 to indicate how long the user has been recording a message.

In FIG. 2B, the user has completed their initial message comprising two message segments (in this case sentences made in relation to document portion 810, although in some cases, the message segments may comprise word or other groupings of words depending on context), as shown in the transcription region 808. More particularly, during the articulation of the second sentence of the message 808.2, the user annotated the active portion of the document using the visualization editing component 326 (e.g., drew a circle and an arrow). These annotative elements were drawn while the user was articulating the second sentence of the recorded message, as indicated by the orange underlining 818 in the transcription region. In particular, a corresponding highlighting component 818 reflecting the annotative elements 812 and 814 drawn by the user to show its association with the second sentence 808.2. The annotation tool can capture the annotative elements drawn by the user and correlate the second sentence with the annotation based on the time of entry of the annotative element matching the time of capture of the second sentence of the recorded message. An annotation object comprising all of the above-articulated aspects of the comment including the annotative elements and which user left the comment may be stored in the data store 122 as annotation 129 as discussed elsewhere herein.

As discussed elsewhere herein, the document application 112 may predictively suggest visualization object elements for annotative elements being drawn by the user using the visualization editing component 326. For example, the content predictor 118 may predict the user is drawing the arrow 814 and suggest a straight, aesthetically polished arrow 816 for adoption by the user (which the user may accept by providing an appropriate confirmatory input or may reject by providing a corresponding rejection input, or which may be automatically accepted depending on the configuration).

As further depicted in FIG. 8C, the user may select playback of any particular message segment in a number of ways, such as by selecting the annotative visualization object 813 in the document portion 810, selecting the second sentence 830 in the transcription region, or selecting the second line segment 831 in the graphical progress bar of the multimodal commenting component 602. Selecting one of these actions will scrub the video player to the beginning of the selected segment, as shown in FIG. 8C (e.g., black scrub line has been moved to the beginning of the second line segment in the graphical progress bar and the second line segment 831 was changed from back to white indicating it is to be played). The user may select to playback the segment 831 by selecting the video region of the multimodal commenting component 602, a playback button 833, or other suitable input mechanism, responsive to which, the multimodal commenting component 602 may render playback of the media (e.g., playback the video via the video region on a display of the user's user device, playback the audio via an audio reproduction device of the user's user device, etc.). The graphical progress bar (depicted in blue) of the multimodal commenting component 602 depicts the duration of the video message made by the user, which in this non-limiting example is eleven seconds long. The progress bar also includes line segments corresponding to each message segment (e.g., sentence). Moving the scrub bar 804 to the beginning (top) of the dial scrubs the video to the beginning and results in both line segments 831 and 834 being white (indicating they are going to be played).

The user may also decide to delete a message segment by selecting a user-selectable delete component 832 associated with that message segment or the annotative visualization object 813. For example, as shown in FIG. 2C, upon selection of the second sentence, a delete “X” icon was depicted. Selection of this delete icon will delete the second sentence of the message from both the video and the transcription region. The user-selectable delete component by be depicted upon hovering over or selecting the desired message segment, or in further cases, may be persistently show for each message segment, although any other suitable selection/deletion mechanism may be used.

As there is an annotation associated with the second sentence, deletion of this message segment would also result in the annotative visualization object 813 being removed from the content region/active document portion, as well as the underlining element 818. In further embodiments, the user may reorder message segments by dragging and dropping the text segments (e.g., sentences) in front or behind other text segments (e.g., move the second sentence in front of the first in the transcription region), responsive to which the document application 112 may reorder the corresponding media segments and the line segments (and highlighting) that correspond to the media and text segments. Any applicable annotative visualization objects would be similarly reordered so they are rendered for display in the content region at the appropriate time/in association with the text and media segments to which they correspond.

Further, if a user inadvertently deletes a message segment, they can reverse the deletion by selecting an undo user interface element (e.g., see FIG. 1), responsive to which, the document application 112 may repopulate the media and transcription region with the corresponding media and text portions that were deleted, as well as the annotation region with the annotation should one have existed (e.g., based on a prior cached version of the document).

In some embodiments, by selecting the annotative object 813, the user may be shown options to delete the annotation and/or may quickly scrub the media player to the point in the message where the annotation was first drawn so the user can easily playback and consume the portion of the message that is specifically related to the annotation (e.g., selecting the annotation scrubs the player to timestamp 0:05, which is the point in time where the user started drawing the annotation as reflected by the underlining).

Turning to FIG. 8D, which continues the example depicted in FIGS. 8A-8C, the user can easily add to or modify an existing media message. For example, as depicted in FIG. 8D, the user revised the message in FIG. 8C by simply recording two more sentences (one replacement sentence and one new sentence) (e.g., by selecting the user-selecting recording element (e.g., on the depicted video, a dedicated record icon, etc.) and annotating the content in the content region by drawing an example of a photo collage. During the further media capture and transcription, the document application 112 captured the new annotative object 842, correlated it with the appropriate portions of the video and the transcribed text, and updated the transcription region to reflect the correlation by highlighting the relevant text portion. The document application 112 also updated the progress bar to reflect the additional two message segments. As in FIG. 8C, the user can easily make further edits to the capture message, or if complete, may select to share the comments expressed by selecting a user-selectable share option, such as that depicted in with respect to interfaces 300, 700 and 900. As described elsewhere herein, the user may define the annotative visualization object 842 using the visualization tools discussed herein, such as the visualization editing component 326, in which case predictive elements 844 may be suggested based on elements 846 drawn by the user.

Responsive to selecting such a share option, the document application 112 may display interface element(s) allowing the user to generate and copy a unique electronically to the document collaboration, send the document collaboration via a file or document sharing application (e.g., via Google docs, etc.) to certain users, send electronic message with a link to the document collaboration to certain users, etc., or other suitable sharing options. A user may select and/or execute the desired sharing option, responsive to which access to the document collaboration is provided to one or more users indicated by the user sharing the document. As a further non-limiting example, a team collaborating on a document may share a link using a messaging application, such as Slack, email, text, etc., and/or the application may include an integration module or plugin for integrating and automating the sharing these messaging applications and/or comments made thereto.

FIG. 8E depicts a further embodiment where a second user adds message segments to the message recorded by the user in FIG. 8D. In FIG. 8E, the prior message from FIG. 8D is depicted on the left. On the right, a second user is recording a message after the second message segment of the first user's message. For instance, the second user select in the transcription region 808 the end of the second sentence of the prior message with an input device (e.g., pointer), and the document application 112 may dynamically display a user-selectable element 880 to begin recording at that point or the user may simply place a cursor there and the multimodal commenting component 602 may scrub the video to that point to being recording there. Responsive to the user selecting to record at this point, the multimodal commenting tool 120 captures the second message and processes it to determine that second user's message contains two message segments (comprising two video segments and two sentences 882 and 883) based on the text transcribed from it. In particular, the text-to-speech engine has returned two sentences 882 along with metadata reflecting their start times and duration in the media recording, and the multimodal commenting tool 120 has analyzed the transcribed text (e.g., punctuation to determine the sentences) and segmented the media recording into two segments based on the analysis and/or metadata. The multimodal commenting tool 120 is dynamically updating the progress bar by inserting corresponding line segments reflecting the corresponding text and media segments in between the second and third-line segments from the prior message. Since the annotation from the prior message is still applicable and the text segments, media segments, and annotative elements are all tied together, the highlighting element 840 moves down with the text segment to which it corresponds in the transcription region as the new text segments from the second message are added. The second user can end the recording by selecting a corresponding pause or end recording user interface element 886. Upon completion, the second user can further reorder, edit, or supplement the message segments as discussed elsewhere herein.

As evidenced by the examples shown in FIGS. 8A-8E, the ability to readily delete, edit, tag, and/or reorder the portions of a media message using dynamically identified, modular message segments are advantageous because users can speak freely without reservation about the target content due to the light-weight nature of the editing process, which makes any clarifications and corrections of any misstatements or errors simple, easy, and enjoyable.

FIG. 8F depicts an embodiment where a user references a particular object in the message, the document application 112 transcribes it, and then processes the transcribed for taggable objects (e.g., object 890). Upon recognizing the particular object as a taggable object, the document application 112 associates the relevant text segment(s) with that object in the database. Using the association, the document application 112 can dynamically notify the tagged user of the comment so the user can immediately respond. For instance, the document application 112 can display a notification interface in the instance of the document application 112 being used by the tagged user, can send an electronic message (e.g., email, text, etc.) to the user using an electronic address stored in the user profile of the tagged user, send a push notification to the tagged user's phone using a stored identifier associated with the user, or other suitable means.

In the case where the tagged object is a location or other proper noun, the document application 112 may query an appropriate data repository for supplemental information associated with that tagged object (e.g., a webpage, map, etc.) and provide it for display in association with the tagged text in the transcription region (e.g., display a window that depicts a summary of the supplementation information (e.g., headline, map, etc.) responsive to the tagged text being hovered or selected by an input device, etc.), etc. Other variations are also possible and contemplated.

For example, as shown in the depicted flowchart, the multimodal commenting tool 120 may convert 892 the speech to text, recognize 894 a reference to a user or other object, may associate the reference with a corresponding object (e.g., associate a user reference with a user account object in the user data), and generate and send a notification to an electronic address associated with the user to notify the user associated with the user account that the user was tagged/of the message.

FIG. 8G depicts another example of a video message captured with the multimodal commenting component 602. For clarity, the video segments 868a-i in the progress bar 866 are shown in different colors to illustrate to which text segments 158a-158i of the transcription region 808 they correspond. For example, the brown video segment 868a corresponds to transcribed text segment 858a, the darker blue video segment 868b corresponds to transcribed text segment 858b, and so forth. During the recording of the video message, the user annotated the content 876 with two sets of annotative visualization elements 870a and 870b. The second set of annotative visualization elements 870b was drawn intermittently over the course of several sentences. As such, the second set 870b is comprised of several annotations made over time, as reflected by the corresponding underlining 860b. Underlining 860a corresponds to first set 870a. The underlining shows the moments in time that the annotative elements were drawn by the user. As described previously, the user may select the underlining or the corresponding portion of the annotation in the content region 876, and then delete that annotative elements (e.g., by selecting a corresponding user-selectable deletion element, pressing a delete button, etc.).

In some embodiments, instead or in addition to colorizing the different segments, when a given segment is being played, about to be played, or the user has scrubbed to player to that segment, the multimodal commenting component 602 may update a subtitle modal or content region 899 to display the text specifically associated with that segment (including any associated annotative highlighting associated with that segment), and so forth. For long messages, this can be advantageous as it can help to declutter the interface.

FIG. 9 depicts another example of the user interface 900 in which playback of a previously recorded video message is being played back and the transcription region is displayed showing the transcribed text (e.g., from FIG. 8G) and the underlining that corresponding to the annotative elements that will be displayed sequentially as the message is played back. As shown, the annotative elements are deemphasized (e.g., relative to FIG. 8G) but visible because playback has just begun. As playback reaches the text corresponding the annotative elements, the annotative elements are drawn to screen in the same order and at the same cadence as when they were initially drawn and explained by the user that created them, so the viewing user may fully benefit from the authoring user's explanation of the underlying content. Further, upon playback of the first comment in the comment region 808, the annotative elements corresponding to that commenter as reflected by underlining 709a and 709b would be similarly drawing to screen, and so on and so forth, so the meaning of the comment can be fully expressed to the other collaborators.

As a given document likely has multiple sections of content that users may wish to collaborate on, the same functionality is provided for each section. For instance, a subsequent next page of the presentation included in the content region 710 (although not depicted) titled Gameplay Mechanics may be scrolled to and users may similarly collaborate on the content of that page using the features and functionality described herein. Beneficially, the messaging layer discussed herein may be included, integrated or overlaid with on any document to provide for an improved, more expressive collaboration experience.

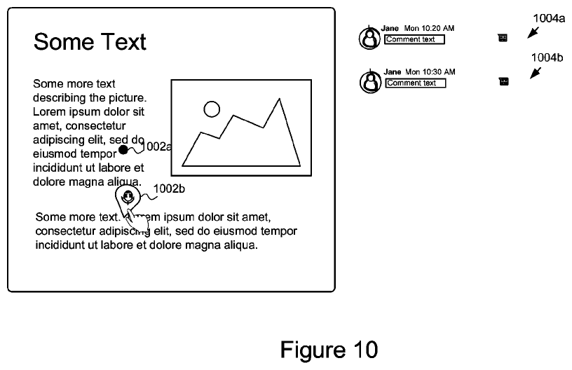

FIG. 10 depicts a further example of a user interface for reviewing and commenting on the active document content where a commenting user can leave a comment anywhere in the active region. For example, the user (e.g., Jane) may have left a first comment in a first location 1002a, and responsive to selecting to leave a second comment in a second location 1002b, may proceed to record his/her comment using an instance of the multimodal commenting tool 602 as discussed elsewhere herein. As discussed elsewhere herein, a user may use various modes for entering the comment including drawing, highlighting, editing, otherwise marking up, recording themselves speaking, entering text, etc. Responsive to selecting a comment location in the active region and recording comments, the document application 112 may populate commenting region of the interface with a corresponding comment entries 1004a and 1004b. On playback, a viewing user may select to listen to the comments in order, may edit and/or reorder the comments, and so forth, as discussed elsewhere herein.

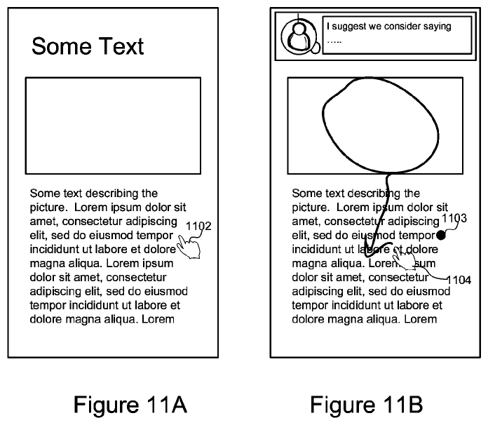

FIGS. 11A and 11B depicts an example mobile user interface. Similar to FIG. 10, a user may add a comment anywhere in the content region by providing a corresponding input 1102 (e.g., tapping, double tapping, etc.), and the document application 112 may display corresponding user interface element(s) showing that the message is being captured. For example, the interface may show an icon 1103 indicating the location of the comment and depict an instance of the multimodal commenting tool 102 with functionality for the user to provide input, such as draw 1004, speak, be transcribed, enter textual comments, dynamically edit and organize the spoken comment, make other annotations, etc.

The described messaging layer provided by the document application 112 via the multimodal commenting component 602 can be beneficially used in a wide variety of contexts. For a company, the document application 112 can be used for external and internal communication. For instance, companies working with clients can use the messaging layer for more effective and interactive sales pitches, demonstrations, customer support, training, and other purposes. Internally, human resources, product teams, and other groups can use the messaging layer for more creative and involved collaboration around documentation, product specifications, legal documents, whitepapers, and other work product. The messaging layer can be particularly effective with technical or difficult-to-understand subject matter, such as legal documents, research papers, homework assignments, lectures, and so forth. Often with this type of subject matter, participation and interaction can suffer because people can easily become overwhelmed and confused. The novel technology discussed herein helps to solve this problem by providing lightweight, easy to use functionality for making content more accessible and understandable, thereby increasing engagement and user conversion. This can be particularly helpful in the education where educators are often confronted with teaching difficult concepts to their pupils. Using the platform disclosed herein, students can be engaged and motivated to provide expressive feedback assignments and other materials, such as providing context for their ideas and work product. These examples are non-limiting and numerous other variations and use cases are also possible and contemplated.

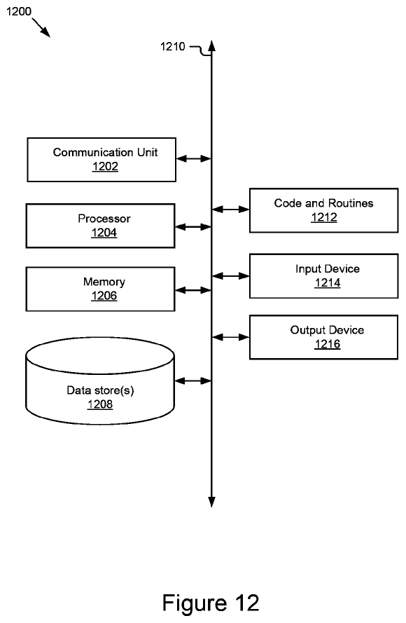

FIG. 12 is a block diagram illustrating an example computing device or system. As depicted, the computing device or system 1200 may include a processor 1204, a memory 1206, a communication unit 1202, an output device 1216, an input device 1214, and data store(s) 1208, which may be communicatively coupled by a communication bus 1210. The computing system 1200 depicted in FIG. 12 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc.

While not shown, the computing system 1200 may include various operating systems, sensors, additional processors, and other physical configurations. Although, for purposes of clarity, FIG. 12 only shows a single processor 1204, memory 1206, communication unit 1202, etc., it should be understood that the computing device or system 1200 may include a plurality of one or more of these components.

The processor 1204 may execute software instructions by performing various input, logical, and/or mathematical operations. The processor 1204 may have various computing architectures to method data signals including, for example, a complex instruction set computer (CISC) architecture, a reduced instruction set computer (RISC) architecture, and/or an architecture implementing a combination of instruction sets. The processor 1204 may be physical and/or virtual, and may include a single core or plurality of processing units and/or cores. In some implementations, the processor 1204 may be capable of generating and providing electronic display signals to a display device, supporting the display of images, capturing and transmitting images, performing complex tasks including various types of feature extraction and sampling, etc. In some implementations, the processor 1204 may be coupled to the memory 1206 via the bus 1210 to access data and instructions therefrom and store data therein. The bus 1210 may couple the processor 1204 to the other components of the computing system 1200 including, for example, the memory 1206, the communication unit 1202, the input device 1214, the output device 1216, and the data store(s) 1208.

The memory 1206 may store and provide access to data to the other components of the computing device or system 1200. The memory 1206 may be included in a single computing device or a plurality of computing devices. In some implementations, the memory 1206 may store instructions and/or data that may be executed by the processor 1204. For example, the memory 1206 may store the code and routines 1212. The memory 1206 is also capable of storing other instructions and data, including, for example, an operating system, hardware drivers, other software applications, databases, etc. The memory 1206 may be coupled to the bus 1210 for communication with the processor 1204 and the other components of computing device or system 1200.

The memory 1206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 1204. In some implementations, the memory 1206 may include one or more of volatile memory and non-volatile memory (e.g., RAM, ROM, hard disk, optical disk, etc.). It should be understood that the memory 1206 may be a single device or may include multiple types of devices and configurations.

The bus 1210 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 1202 may include one or more interface devices (I/F) for wired and wireless connectivity among the components of the system 100. For instance, the communication unit 1202 may include various types known connectivity and interface options. The communication unit 1202 may be coupled to the other components of the computing device or system 1200 via the bus 1210. The communication unit 1202 may be electronically communicatively coupled to a network (e.g., wiredly, wirelessly, etc.). In some implementations, the communication unit 1202 can link the processor 1204 to a network, which may in turn be coupled to other processing systems. The communication unit 1202 can provide other connections to a network and to other entities of the device or system 100 using various standard communication protocols.

The input device 1214 may include any device for inputting information into the computing system 1200. In some implementations, the input device 1214 may include one or more peripheral devices. For example, the input device 1214 may include a keyboard, a pointing device, microphone, an image/video capture device (e.g., camera), a touch-screen display integrated with the output device 1216, etc.

The output device 1216 may be any device capable of outputting information from the computing system 1200. The output device 1216 may include one or more of a display (LCD, OLED, etc.), a printer, a 3D printer, a haptic device, audio reproduction device, touch-screen display, etc. In some implementations, the output device is a display which may display electronic images and data output by the computing system 1200 for presentation to a user, such as a picker or associate in the order fulfillment center. In some implementations, the computing system 1200 may include a graphics adapter (not shown) for rendering and outputting the images and data for presentation on output device 1216. The graphics adapter (not shown) may be a separate processing device including a separate processor and memory (not shown) or may be integrated with the processor 1204 and memory 1206.

The database(s) are information source(s) for storing and providing access to data. The data stored by the data store(s) 1208 may be organized and queried using various criteria including any type of data stored by them, such as the data in the data store 122 and other data discussed herein. The data store(s) 1208 may include file systems, data tables, documents, databases, or other organized collections of data. Examples of the types of data stored by the data store(s) 1208 may include the data described herein, for example, in reference to the data store 122.

The data store(s) 1208 may be included in the computing system 1200 or in another computing system and/or storage system distinct from but coupled to or accessible by the computing system 1200. The data store(s) 1208 can include one or more non-transitory computer-readable mediums for storing the data. In some implementations, the data store(s) 1208 may be incorporated with the memory 1206 or may be distinct therefrom. In some implementations, the data store(s) 1208 may store data associated with a database management system (DBMS) operable on the computing system 1200. For example, the DBMS could include a structured query language (SQL) DBMS, a NoSQL DMBS, an object store, and key/value store, various combinations thereof, etc. In some instances, the DBMS may store data in multi-dimensional tables comprised of rows and columns, and manipulate, e.g., insert, query, update and/or delete, rows of data using programmatic operations.

Appendix A forms part of this application and is incorporated by reference in its entirety.

The foregoing description, for purpose of explanation, has been described with reference to various embodiments and examples. However, the illustrative discussions above are not intended to be exhaustive or to limit the invention to the precise forms disclosed. Many modifications and variations are possible in view of the above teachings. The various embodiments and examples were chosen and described in order to best explain the principles of the invention and its practical applications, to thereby enable others skilled in the art to utilize the innovative technology with various modifications as may be suited to the particular use contemplated.

1. A computer-implemented method, comprising:
generating a document interface including a document content region configured to display textual and graphical document elements, the document interface including a visualization input component that is user-selectable to input visualization object elements;
providing the document interface for presentation via an output device of a computing device associated with a user;
receiving a first input via an input device associated with the computing device;
predicting one or more first visualization object elements based on the first input;
updating the document interface to include the one or more predicted first visualization object elements as one or more suggestions;
receiving an annotative input defining an annotative visualization object having one or more visualization object elements;
predicting an optimized annotative visualization object based on the annotative input;
provide the optimized annotative visualization object for presentation via the document interface;
receive an acceptance of the optimized annotative visualization object; and
replace the annotative visualization object with the optimized annotative visualization object.

2. The computer-implemented method of claim 1, wherein predicting the one or more first visualization object elements based on the first input comprises:
determining one or more contextual inputs based on one or more earlier-defined visualization object elements;
generating one or more first visualization object element predictions based on the first input and the one or more contextual inputs; and
determining the one or more predicted first visualization object elements based on the one or more first visualization object element predictions.

3. The computer-implemented method of claim 2, wherein determining the one or more predicted first visualization object elements based on the one or more first visualization object element predictions comprises filtering the one or more first visualization object element predictions based on a confidence threshold.

4. The computer-implemented method of claim 1, further comprising:
determining the first input to be a first visualization design input;
receiving a second input;
determining the second input to be a second visualization design input; and
predicting one or more second visualization object elements based on the first visualization design input and the second visualization design input.

5. The computer-implemented method of claim 4, further comprising:
determining a mathematical relationship between the first input and the second input; and
mathematically associating the one or more first visualization object elements and one or more second visualization object elements based on the mathematical relationship.

6. The computer-implemented method of claim 5, further comprising:
receiving a third input modifying an attribute of an element from the one or more first visualization object elements and the one or more second visualization object elements;
computing an output based on the mathematical association between the one or more first visualization object elements and the one or more second visualization object elements; and
updating the document interface to reflect the output.

7. The computer-implemented method of claim 1, wherein updating the document interface to include the one or more predicted first visualization object elements comprises one of:
updating the document interface to suggest a graphical object;
updating the document interface to suggest an element for the graphical object;
updating the document interface to suggest supplementing the graphical object;
updating the document interface to suggest supplementing the element for the graphical object;
updating the document interface to suggest reformatting the graphical object;
updating the document interface to suggest reformatting an existing element of the graphical object;
updating the document interface to suggest replacing the graphical object; and
updating the document interface to suggest replacing the existing element of the graphical object.

8. The computer-implemented method of claim 5, wherein:
a graphical object comprises one or more one of a graph, chart, table, diagram, and drawing; and
a graphical object element comprises one or more of a shape, line, dot, legend, title, text, shadow, color, thickness, texture, fill, spacing, positioning, ordering, and shading.

9. The computer-implemented method of claim 1, wherein predicting the one or more first visualization object elements based on first input includes predicting that the one or more first visualization object elements reflect one or more elements of a graph;
receiving a second input;
determining the second input to include one or more values for the one or more elements of the graph; and
updating the document interface to include one or more second suggested graphical elements having one or more adjusted dimensional attributes based on the one or more values.

10. The computer-implemented method of claim 1, wherein the visualization input component is draggable.

11. A computer-implemented method, comprising:
receiving an input to capture a media stream via a media capture device in association with a document;
capturing the media stream;
transcribing the media stream to text;
segmenting the media stream into a segmented media stream object based on the transcribed text;
providing a media player configured to playback the segmented media stream object;
generating a document interface including a document region and a multimodal commenting component having a transcription region configured to display the transcribed text and the media player;
providing the document interface for presentation via an input device of a computing device associated with a user;
receiving an annotative input defining an annotative visualization object having one or more visualization object elements while the media stream is being captured;
determining an annotation timestamp based on a media stream playback time;
storing an annotative visualization object in association with the document, the annotative visualization object including the segmented media object, the one or more visualization object elements, and the timestamp;
updating the document interface to depict the annotative visualization object;
predicting an optimized annotative visualization object based on the annotative input;
provide the optimized annotative visualization object for presentation via the document interface;
receive an acceptance of the optimized annotative visualization object; and
replace the annotative visualization object with the optimized annotative visualization object.

12. The computer-implemented method of claim 11, wherein each segment of the segmented media object corresponds to a phrase in the transcribed text.

13. (canceled)

14. The computer-implemented method of claim 11, further comprising:
while capturing the media stream, playing back the media stream in the media player and contemporaneously updating the transcription region with the transcribed text.

15. The computer-implemented method of claim 11, wherein segmenting the media object based on the transcribed text comprises determining two or more sequential phrases comprised by the transcribed text and tagging the media object with two or more timestamps corresponding to the two or more sequential phrases.

16. (canceled)

17. (canceled)

18. The computer-implemented method of claim 11, further comprising:
receiving a media playback input;
determining one or more annotative visualization objects associated with the media playback input, each of the one or more annotative visualization objects including an annotation timestamp;
playing back the segmented media stream object via the media player; and
providing the one or more annotative visualization objects for presentation in association with the playing back of the segmented media stream object based on the annotation timestamp of each of the one or more annotative visualization objects.

19. A system, comprising:
a processor; and
a memory storing instructions that, when executed by the processor, cause the system to perform operations comprising:
generating a document interface including a document content region configured to display textual and graphical document elements, the document interface including a visualization input component that is user-selectable to input visualization object elements;
providing the document interface for presentation via an output device of a computing device associated with a user;
receiving a first input via an input device associated with the computing device;
predicting one or more first visualization object elements based on the first input;
updating the document interface to include the one or more predicted first visualization object elements as one or more suggestions;
receiving an annotative input defining an annotative visualization object having one or more visualization object elements;
predicting an optimized annotative visualization object based on the annotative input;
provide the optimized annotative visualization object for presentation via the document interface;
receive an acceptance of the optimized annotative visualization object; and
replace the annotative visualization object with the optimized annotative visualization object.

20. A system, comprising:
a processor; and
a memory storing instructions that, when executed by the processor, cause the system to perform operations comprising:
receiving an input to capture a media stream via a media capture device in association with a document;
capturing the media stream;
transcribing the media stream to text;
segmenting the media stream into a segmented media stream object based on the transcribed text;
providing a media player configured to playback the segmented media stream object;
receiving an annotative input defining an annotative visualization object having one or more visualization object elements;
predicting an optimized annotative visualization object based on the annotative input;
provide the optimized annotative visualization object for presentation via the document interface;
receive an acceptance of the optimized annotative visualization object; and
replace the annotative visualization object with the optimized annotative visualization object.
